(19) United States
(12) Patent Application Publication
(10) Pub. No.: US 2025/0161931 A1
(43) Pub. Date: May 22, 2025

(54) SYSTEM FOR PARALLEL SAMPLING HAVING INDEPENDENT MEASURING DEVICES WITH AN OPTIONAL CENTRAL COLLECTION DEVICE OR A STERILE BAG MANIFOLD

(71) Applicant: Flownamics Analytical Instruments, Inc., Madison, WI (US)

(72) Inventor: Michael Biksacky, Madison, WI (US)

(21) Appl. No.: 19/029,439

(22) Filed: Jan. 17, 2025

Related U.S. Application Data
(63) Continuation of application No. 18/816,998, filed on Aug. 27, 2024.
(60) Provisional application No. 63/579,146, filed on Aug. 28, 2023.

(51) Int. Cl. B01L 3/02

(52) U.S. Cl. CPC B01L 3/0227; B01L 2300/0663; B01L 2300/0681; B01L 2400/0622; B01L 2400/0633

(57) ABSTRACT

A system for parallel sampling used for sampling of bacterial and mammalian cultures, the system comprises a disposable syringe valve assembly having a disposable valve with a plurality of ports and a disposable syringe or pump, a sampling device on which the disposable syringe valve assembly is removably coupled, a disposable sampling probe for acquisition of a fluid sample, a fluid handler assembly for a distribution of the fluid sample, a disposable expandable fluid containment manifold drive for a storage of the fluid sample, and a filter cap vial assembly for a storage of the fluid sample.

### CROSS-REFERENCES TO RELATED APLICATIONS

This application claims claim priority from U.S. application Ser. No. 18/816,998, entitled “SYSTEM FOR PARALLEL SAMPLING HAVING INDEPENDENT MEASURING DEVICES WITH AN OPTIONAL CENTRAL COLLECTION DEVICE OR A STERILE BAG MANIFOLD”, filed Aug. 27, 2024; which claims the benefit of U.S. Provisional Application No. 63/579,146, entitled “SYSTEM FOR PARALLEL SAMPLING HAVING INDEPENDENT MEASURING DEVICES WITH AN OPTIONAL CENTRAL COLLECTION DEVICE OR A STERILE BAG MANIFOLD”, filed Aug. 28, 2023.

### FIELD

The present invention relates to the field of sampling and dispensing. The present invention more specifically relates to the field of sample collection, storage and analysis.

### BACKGROUND

Both food product and therapy industries have and remain to have an interest in developing cultures for the growth of solutions. In food product industries for example, bacteria and yeast cultures are growth for the creation of yogurt based products and in the beverage industry. In therapy industries, gene cultures are created for the research in viral and bacterial remedies. Further gene cultures may be developed for autoimmune gen based therapy and the development of tissue growth.

With that, the industry understands the historical cost and technological difficulties in applying such technology to various applications. Historical a culture reactor, and multiple testing stations are required to ensure a sample is sufficient both as a product and lacks contaminations. Further the sample was then required to be transferred to a storage apparatus. However, the cost has been significant for each test required a separate machine. Further, the ability to clean a sampling system and transfer to a different culture for sampling was hindered because the system was required to be disabled for cleaning which resulted in potential airborne and foreign contaminants entering the system. Such a contamination would result in eventual contamination of the samples taken later in time. Further, sampling in the art results in collection of undesired air and/or foam into the sample when taken from the culture or reactor. Further, where sampling changes from cell contained to non-cell contained component probe samples are required to be changed resulting in potential contamination in the culture or reactor. With that, there is a need for sampling system which provides the ability to sample consecutive cultures and provide for sterilization of the system with minimal removal of parts of the system. Further a need exists for reduction of the number of testing devices applied for testing a sample.

Thus, there is a need for a sampling module/sampling devices with the capability to provide for multiple tests.

Thus, there is a need for a sampling module/sampling devices that can accurately calculate flow rate and/or volume of samples.

Thus, there is a need for disposable sampling probes/probes/dip tubes that are less likely to pull or process sample foam or air bubbles, and a parallel sampling system utilizing same.

Thus, there is a need for a disposable sampling probes/probes/dip tubes that has a longer effective life.

Thus, there is a need to a combination disposable sampling probes/probes/dip tubes that can pull (e.g., simultaneously pull) filtered and unfiltered fluid, and a parallel sampling system utilizing same.

Thus, there is a need for a fluid handler assembly/central processing and/or collection stations that can collect samples pulled in parallel and provide (e.g., simultaneously provide) the samples to a sample distribution system for delivery to multiple analytical devices.

Thus, there is a need for an apparatus that can receive fluid from a sample distribution system or other reservoir, disperse or direct it to one or more bags or reservoirs of the apparatus, be cleaned or sterilized, and receive other fluid from a sample distribution system, and disperse or direct it to other bags or reservoirs of the bag or reservoir apparatus.

### SUMMARY

Accordingly, a system (e.g., system for parallel sampling) and/or various system devices (e.g., independent devices), configured to take, pull or draw filtered or unfiltered fluids or both from a vessel (e.g., a single or multi-use vessel, a reactor, or process stream) and deliver it to a detector, analyzer or collector is provided. The system includes innovative a disposable syringe valve assembly, sampling modules/sampling devices, disposable sampling probes/probes/dip tubes, filter cap vial assembly, fluid handler assembly/central processing and/or collection stations, and a disposable expandable fluid containment manifold drive and/or sterile bag/reservoir manifold apparatus.

Accordingly, an example of a disposable syringe valve assembly is disclosed herein. The disposable syringe valve assembly comprises a disposable syringe, a disposable valve, and a motor housing. The disposable valve may have a plurality of ports about a perimeter of the disposable valve. The disposable valve may have an adjustable dial between each of the plurality of ports, with adjustable dial allowing for a movement of fluid to a port of the plurality of ports. The disposable syringe may be removably attached to a port of the plurality of ports. The motor housing may be operatively connected to one or more of the disposable valve and the disposable syringe to provide for a withdrawal of fluid from the disposable syringe. A second port of the plurality of port may be for a removal of the fluid to one or more of a collector and an analyzer.

Accordingly, an example of a sampling module/sampling device is disclosed herein. The sampling device comprises the features of the disposable syringe valve assembly and a motor housing operatively connected to one or more of the disposable valve and the disposable syringe to provide for a withdrawal of fluid from the disposable syringe. The sampling device may further include: the motor housing is a plurality of motor housings; one or more of a sensor and a probe removable attached to a third port of the plurality of ports, a fourth port of the plurality of ports, a fifth port of the plurality of ports, and a sixth port of the plurality of ports for a measurement of a substance within the fluid; the disposable valve allowing for portions of the fluid positioned in the disposable syringe for the movement of the fluid to multiple ports of the plurality of ports; removable attachment of one or more or a sterile bag or a sterile vial at one or more ports of the plurality of ports; one of a reactor and a process stream removably attached to a port of the plurality of ports removably for a receipt of the fluid; one of a second reactor and a second process stream removably attached to a port of the plurality of ports removably for a receipt of the fluid; a second disposable syringe with a tubing operatively connected to one of the reactor and the process stream, with the disposable syringe and the second disposable syringe operatively removing the fluid from one of the reactor and the process stream; the second disposable syringe operatively returns a portion of the fluid to one of the reactor and the process stream; a tee-connection in fluid connection with one of the reactor and the process stream; and a second disposable valve

Accordingly, an example a disposable sampling probe/probe/dip tube is disclosed herein. The disposable sampling probe may comprise: a main body having a longitudinal dimension; a fluid path housed in the main body and operatively connected to a collection apparatus positioned along the longitudinal dimension, the collection apparatus may be one of a filter positioned on the housing and an angled inlet port; the fluid path may have an outlet opposite the collection apparatus along the longitudinal dimension; a tubing may be fluidly connected to the outlet; a check valve may be in fluid connection to the main body, proximate to the outlet; and the disposable sampling probe may positioned in one of a reactor and a process stream. The disposable sampling probe may have multiple fluid paths. The angled inlet port may be positioned at a 45 degree angle on a side of the main body along the longitudinal dimension, with the angled inlet port being a hinderance to inclusion of an air or a foam in the fluid path. The main body may be slidably positioned in a probe sleave having an open end, with the main body slidably extending beyond the open end for an exposure of the collection apparatus.

Accordingly, an example filter cap vial assembly is disclosed herein. The filter cap vial assembly may comprise: a vial with an opening to a vial cavity defined by a body of the vial; a cap having one or more through-holes in removable connection with the vial over the opening; a filter material positioned between the cap and the vial, with the combination of the one or more through-holes and the filter material being an access for air to be in the vial cavity to be released from the vial cavity during a filling of the vial cavity with a fluid; and a tubing in fluid connection through the cap with the vial cavity.

Accordingly, an example fluid handler assembly/central processing and/or collection station is disclosed herein. The fluid handler assembly comprises a fluid handler positioned proximate to a reservoir; one or more fluid direction valves positioned on the fluid handler with each of the one or more fluid direction valves in fluid communication with a sampling device; a plurality of connections for fluid access to the reservoir; a second reservoir for a transfer of a portion of the fluid to waste; and a wash station to clean the fluid handler.

Accordingly, an example disposable expandable fluid containment manifold drive and/or sterile bag/reservoir manifold apparatus comprises: a disposable valve and a control housing operably connected to one another; the disposable valve has a valve assembly and at least one valve port; the valve assembly is operatively positioned in the disposable valve and fluidly connected with the at least one valve port; a fluid container is fluidly connected to the at least one valve port; the control housing is positioned to direct a fluid to the at least one valve port; and electronics for electrical operation of one more of the control housing and the disposable valve.

Accordingly, a sampling device/sampling module may be used to calculate flow rate and/or volume, and a parallel sampling system utilizing same.

Accordingly, a central processing and/or collection station that can collect samples pulled in parallel and provide (e.g., simultaneously provide) the samples to a sample distribution system (e.g., as called for by the sample delivery system) for delivery to multiple analytical devices, and a parallel sampling system utilizing same is disclosed herein.

These and other features and advantages of devices, systems, and methods according to this invention are described in, or are apparent from, the following detailed descriptions of various examples of embodiments.

### BRIEF DESCRIPTION OF DRAWINGS

Various examples of embodiments of the systems, devices, and methods according to this invention will be described in detail, with reference to the following figures, wherein:

FIG. 1 illustrates a perspective view of a first aspect of a disposable sampling probe, a dip tube according to various examples of embodiments;

FIG. 2 illustrates an end view of the first aspect of the disposable sampling probe, the dip tube, of FIG. 1;

FIG. 3 illustrates a front view of indeterminate length of the first aspect of the disposable sampling probe, the dip tube, of FIG. 1;

FIG. 4 illustrates a side cross-sectional view of indeterminate length of the first aspect of the disposable sampling probe, the dip tube, of FIG. 3 taken along section A-A;

FIG. 5 illustrates a side view of indeterminate length of the first aspect of the disposable sampling probe, the dip tube, of FIG. 1;

FIG. 6 illustrates a side view of a second aspect of the disposable sampling probe, a probe, and a side view of a sleeve housing, according to various examples of embodiments;

FIG. 7 illustrates a side view of a combination the second aspect of the disposable sampling probe, the probe, with the sleeve in a first stage, according to various examples of embodiments;

FIG. 8 illustrates a side view of the combination the second aspect of the disposable sampling probe, the probe, with sleeve of FIG. 7, in a second stage, according to various examples of embodiments;

FIG. 9 illustrates a perspective view of a third aspect of the disposable sampling probe, a second probe, according to various examples of embodiments;

FIG. 10 illustrates an exploded view of the third aspect of the disposable sampling probe, a second probe, of FIG. 9;

FIG. 11 illustrates a perspective view of the third aspect of the disposable sampling probe, a second probe, of FIG. 9, with a check valve positioned proximate;

FIG. 12 illustrates an exploded perspective view of the third aspect of the disposable sampling probe, a second probe, of FIG. 9, with the check valve positioned proximate;

FIG. 13 illustrates a perspective view of the check valve of FIG. 11.

FIG. 14 illustrates a side view of the check valve of FIG. 11.

FIG. 15 illustrates a front view of the check valve of FIG. 11.

FIG. 16 illustrates an example filtration system having a harvest line from which fluid may be harvested for collection or analysis, according to various examples of embodiments;

FIG. 17 illustrates a cross-sectional view of a fourth aspect of the disposable sampling probe, a combination dip tube and probe, according to various examples of embodiments;

FIG. 18 illustrates a cross-sectional view of a fifth aspect of the disposable sampling probe, a combination dip tube and probe, according to various examples of embodiments;

FIG. 19 illustrates a perspective view of a first aspect of a sampling module/sampling device, according to various examples of embodiments;

FIG. 20 illustrates a perspective view of the first aspect of the sampling module/sampling device, according to various examples of embodiments;

FIG. 21 illustrates a front view of the first aspect of the sampling module/sampling device, of FIG. 20;

FIG. 22 illustrates a front view of a second aspect of the sampling module/sampling device, according to various examples of embodiments;

FIG. 23 illustrates a first side perspective view of the second aspect of the sampling module/sampling device of FIG. 22;

FIG. 24 illustrates a second side perspective view of the second aspect of the sampling module/sampling device of FIG. 22;

FIG. 25 illustrates a perspective view of a tee connector of the sampling module of FIG. 22, according to various examples of embodiments;

FIG. 26 illustrates a cutaway perspective view of the tee connector of FIG. 25;

FIG. 27 illustrates a first exploded perspective view of the tee connector of FIG. 25;

FIG. 28 illustrates a second exploded perspective view of the tee connector of FIG. 25;

FIG. 29 illustrates a perspective view of a third aspect of the sampling module/sampling device, according to various examples of embodiments;

FIG. 30 illustrates a cutaway perspective view of the third aspect of the sampling module/sampling device of FIG. 29;

FIG. 31 illustrates the third aspect of the sampling module/sampling device of FIG. 29, with additional lines, a valve and tee fitting fluidly coupled thereto, according to various examples of embodiments;

FIG. 32 illustrates a perspective view of a disposable syringe valve assembly, according to various examples of embodiments;

FIG. 33 illustrates a front view of the disposable syringe valve assembly of FIG. 32;

FIG. 34 illustrates a side view of a syringe cover, sleeve or bellows, according to various examples of embodiments;

FIG. 35 illustrates an end view of the syringe cover, sleeve or bellows of FIG. 34;

FIG. 36 illustrates a cross-sectional view of the syringe cover, sleeve or bellows of FIG. 34, taken along section A-A;

FIG. 37 illustrates a side view of a first side of a first aspect of a fluid handler assembly/central processing station and tubing, according to various examples of embodiments;

FIG. 38 illustrates a perspective view of the first side of the first aspect of a fluid handler assembly/central processing station of FIG. 37;

FIG. 39 illustrates a bottom perspective view of a second aspect of the fluid handler assembly/central processing station, according to various examples of embodiments;

FIG. 40 illustrates a top perspective view of the second aspect of the fluid handler assembly/central processing station of FIG. 39;

FIG. 41 illustrates an exploded perspective view of the second aspect of the fluid handler assembly/central processing station of FIG. 39;

FIG. 42 illustrates a bottom perspective view of a third aspect of the fluid handler assembly/central processing station, according to various examples of embodiments;

FIG. 43 illustrates a top perspective view of the third aspect of the fluid handler assembly/central processing station of FIG. 42;

FIG. 44 illustrates an exploded perspective view of the third aspect of the fluid handler assembly/central processing station of FIG. 42;

FIG. 45 illustrates a perspective view of the first side of the first aspect of the fluid handler assembly/central processing station and tubing, according to various examples of embodiments;

FIG. 46 illustrates a perspective view of a fourth aspect of the fluid handler assembly/central processing station, according to various examples of embodiments;

FIG. 47 illustrates an exploded perspective view of the fourth aspect of the fluid handler assembly/central processing station of FIG. 46;

FIG. 48 illustrates a front view of the fourth aspect of the fluid handler assembly/central processing station of FIG. 46;

FIG. 49 illustrates a perspective view of a fifth aspect of the fluid handler assembly/central processing station, according to various examples of embodiments;

FIG. 50 illustrates a perspective view of a fifth aspect of the fluid handler assembly/central processing station of FIG. 49;

FIG. 51 illustrates a sampling module fluidly coupled to a first aspect of a sterile bag/reservoir manifold apparatus, according to various examples of embodiments;

FIG. 52 illustrates a partial perspective view of the first aspect of the sterile bag/reservoir manifold apparatus of FIG. 51;

FIG. 53 illustrates a perspective view of the first aspect of the sterile bag/reservoir manifold apparatus of FIG. 52;

FIG. 54 illustrates a cutaway perspective view of the first aspect of the sterile bag/reservoir manifold apparatus of FIG. 52;

FIG. 55 illustrates a perspective view of a second aspect of the sterile bag/reservoir manifold apparatus, according to various examples of embodiments;

FIG. 56 illustrates an exploded perspective view of the second aspect of the sterile bag/reservoir manifold apparatus of FIG. 55;

FIG. 57 illustrates a schematic view of a tube manifold apparatus/disposable syringe valve assembly, sampling modules/sampling devices, according to various examples of embodiments;

FIG. 58 illustrates a schematic view of the tube manifold apparatus/disposable syringe valve assembly, sampling modules/sampling devices fluidly coupled to a bag/reservoir, according to various examples of embodiments;

FIG. 59 illustrates a front view of a vial or tube assembly/filter cap vial assembly of a tube manifold apparatus, according to various examples of embodiments;

FIG. 60 illustrates a front view of the vial or tube assembly/filter cap vial assembly of a tube manifold apparatus, according to various examples of embodiments;

FIG. 61 illustrates an exploded view of the vial or tube assembly/filter cap vial assembly of FIG. 60;

FIG. 62 illustrates a top view of a cap of vial or tube assembly/filter cap vial assembly of FIG. 60;

FIG. 63 illustrates a perspective view of a multi position valve, according to various examples of embodiments;

FIG. 64 illustrates a first side view of the multi position valve of FIG. 63;

FIG. 65 illustrates a second side view of the multi position valve of FIG. 63;

FIG. 66 illustrates a front view of the multi position valve of FIG. 63;

FIG. 67 illustrates a sectional view of the multi position valve of FIG. 66, taken along section A-A;

FIG. 68 illustrates a perspective view of the multi position valve of FIG. 66, taken along section C-C;

FIG. 69 illustrates a perspective view of a sixth aspect of the fluid handler assembly/central processing station, according to various examples of embodiments;

FIG. 70 illustrates an exploded perspective view of a sixth aspect of the fluid handler assembly/central processing station of FIG. 69; and

FIG. 71 illustrates a perspective view of a seventh aspect of the fluid handler assembly/central processing station of FIG. 69.

It should be understood that the drawings are not necessarily to scale. In certain instances, details that are not necessary to the understanding of the invention or render other details difficult to perceive may have been omitted. It should be understood, of course, that the invention is not necessarily limited to the particular embodiments illustrated herein.

### DETAILED DESCRIPTION

Referring to the Figures, a system (e.g., system for parallel sampling) that is configured to take, pull or draw filtered or unfiltered fluids or both from a vessel (e.g., a single or multi-use vessel, a reactor, or process stream) and deliver it to a detector, analyzer or collector is provided. In various embodiments, sterile air or a gas moves the fluid throughout the system. There are a number of configuration options for this system.

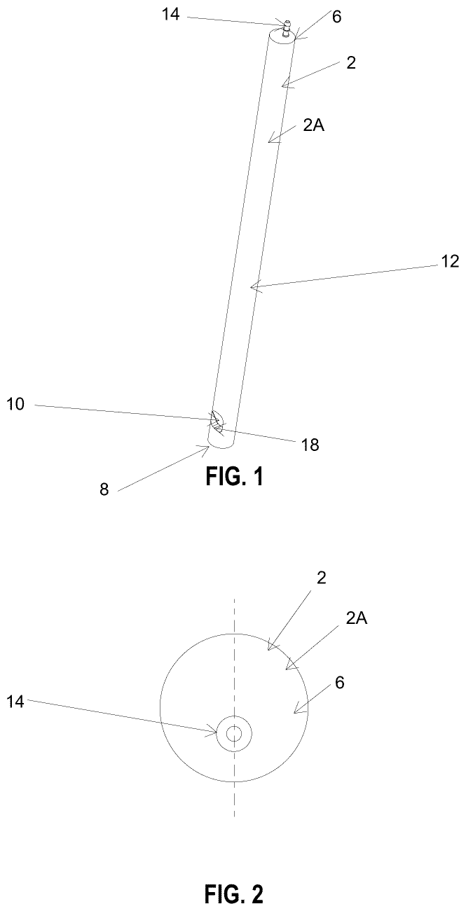

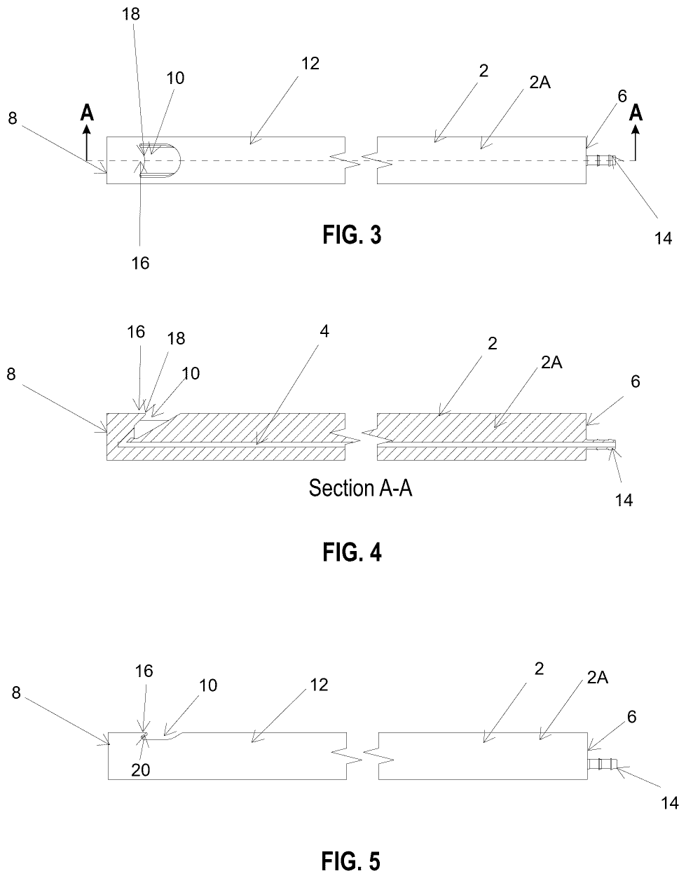

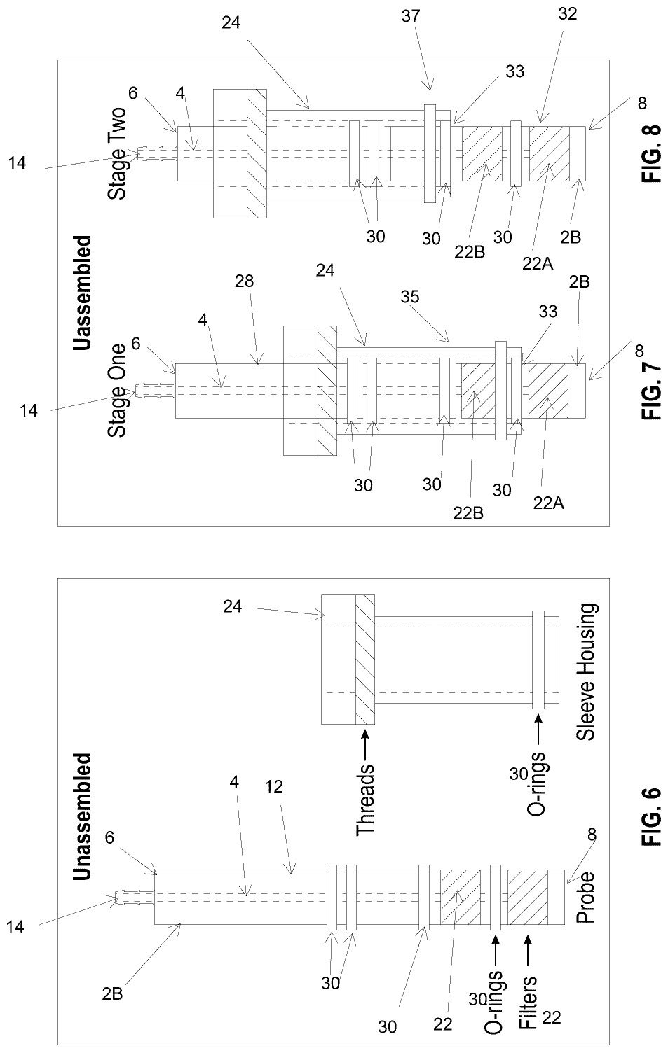

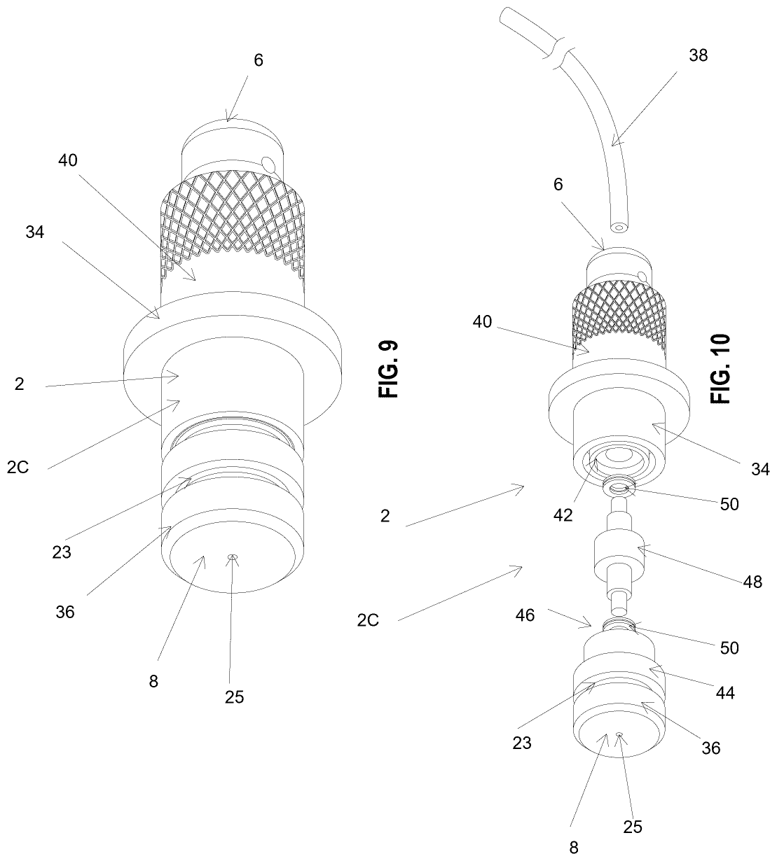

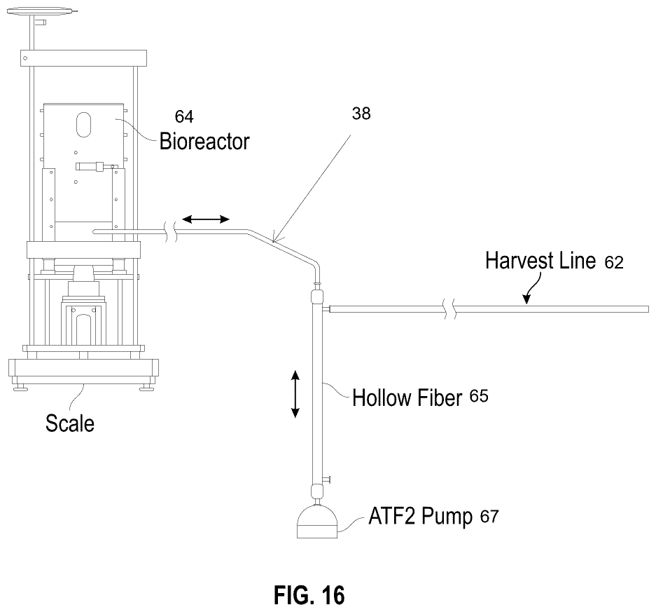

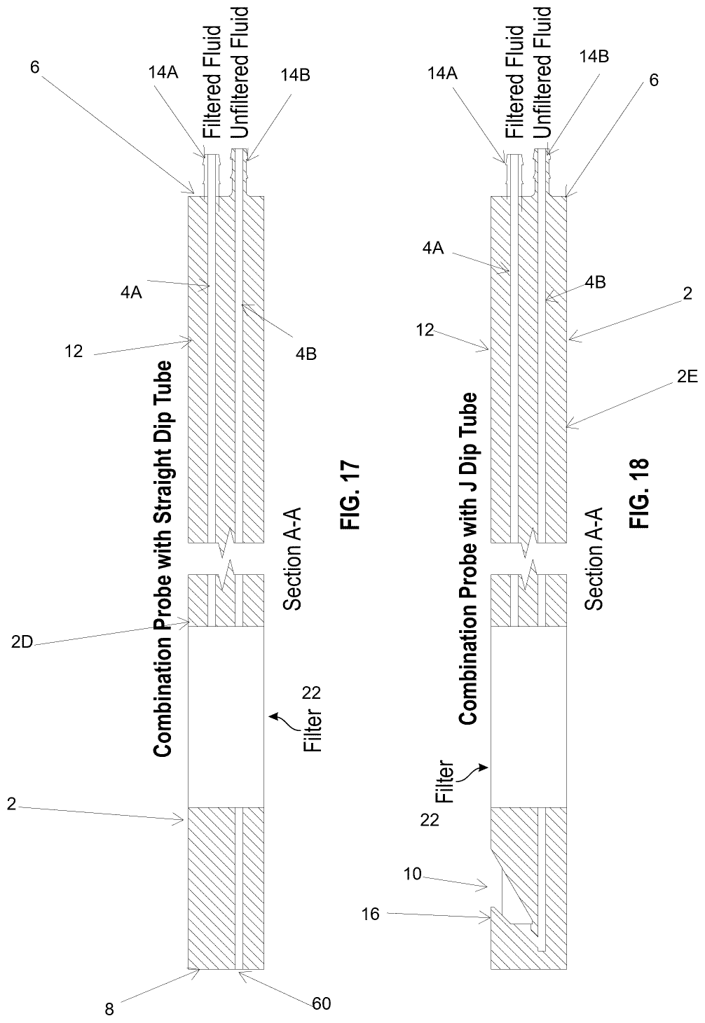

With attention to FIGS. 1 to 12 and 17 and 18, various aspects of a disposable sampling probe 2 are illustrated. In various embodiments, the system (e.g., system for parallel sampling) is provided with one of the first aspect of a first aspect of the disposable sampling probe 2A (see FIGS. 1 to 5), a second aspect of the disposable sampling probe 2B (see FIGS. 6 to 8), a third aspect of the disposable sampling probe 2C (see FIGS. 9 to 12), a fourth aspect of the disposable sampling probe 2D (see FIG. 17), and a fifth aspect of the disposable sampling probe 2E (see FIG. 18). It is understood each aspect of the disposable probe (2A, 2B, 2C, 2D, and 2E) incorporates an features of one or more of the aspects of the disposable probe (2A, 2B, 2C, 2D, and 2E). Referring to FIGS. 1-5, first aspect of the disposable sampling probe 2A, the probe or dip-tube defines an internal conduit or diameter 4 that extends between opposing ends (a first end 6, and an opposite second end 8) of the probe or dip-tube 2A to an inlet 10 defined in an outer surface or outer diameter of a side 12 of the probe 2A to dip-tube that is in fluid communication with the internal conduit or diameter 4. In various embodiments, the internal conduit or diameter 4 extends from the inlet 10 to an outlet 14 provided on one opposing first end 6. As shown in the Figures, the internal conduit or diameter 4 is offset from a longitudinal center (not illustrated in the figures) of the probe or dip-tube 2 and, in various aspects, away from the side 12 of the probe or dip-tube 2A defining the inlet 10. In various aspects, the inlet 10 is partially defined by a shroud 16 provided at a bottom 18 of the inlet 10 and/or an angled side wall extending at an acute angle relative to the internal conduit or diameter. The acute angle is preferably a 45 degree angle. The acute angle may be less than 45 degrees or may be greater than 45 degrees. The position of the inlet 10 in the side 12 of the probe 2A (rather than in the second end 8 opposing the first end 6 coupled to the outlet 14), the shroud 16 and/or the acutely angled side wall 20, helps prevent process air and/or bubbles or the like from entering the internal diameter of the probe/dip-tube. As a result, more fluid relative to air is removable from a vessel 64, see FIG. 16. Please note the reactor 64 may be any time of reactor know in the art.

With attention to FIGS. 6 to 8, a second aspect of the disposable sampling probe 2B (e.g., if filtered fluid is required or to be drawn from the vessel), the probe fitted or otherwise provided with a filter or membrane 22 is provided in a retractable sleeve housing 24. An example housing 24 is the Intrac 787 brand retractable housing of Metter Toledo, Ohio. In various embodiments, the retractable housing 24 allows withdrawal of the probe 2B fitted with a filter or membrane 22 from the reactor 64, see FIG. 16, in a sterile fashion. The filter or membrane 22 on the probe 2B may then be cleaned in an external compartment (not illustrated in the figures). In various aspects, the external compartment is the same compartment in which the probe 2B is sterilized prior to being inserted, or reinserted back, into the reactor vessel 64, see FIG. 16. The filter or membrane 22 may be cleaned with steam on the outside surface 26 of the filter or membrane 22 or by treating the filter or membrane 22 with a cleaning reagent. The probe 2B may also be removed from the retractable housing and replaced with a new probe 2B, or the filter or membrane 22 on the existing probe 2B may be replaced and the probe 2B reinserted back into the retractable housing 24.

In various embodiments, the condition of the filter or membrane 22 is monitored by measuring the flowrate and/or volume of fluid coming from the probe 2B. For example, in various embodiments, a first flowrate measurement of flow rate coming from the probe 2B or the historical flowrate data for the membrane 22 is used as a reference flowrate for future or later flowrate measurements. If a later measured flowrate deviates from the reference flowrate, the operator is notified, and the probe 2B may be removed from the vessel and into the retractable housing 24 (e.g., by means of an automated process). In various embodiments, the filter or membrane 22 is cleaned, and the probe is sterilized and reinserted back into the reactor vessel 64, see FIG. 16. The retraction, cleaning, sterilization, and reinsertion of the probe 2B can be a manual or automated process.

Additionally, in various aspects (e.g., if filtered fluid is required or to be drawn from the reactor vessel 64, see FIG. 16), a probe 2B is fitted or otherwise provided with the one or more filters or membranes 22. In various embodiments, the probe 2B is inserted or provided into the reactor vessel 64, see FIG. 16.

As further illustrated in FIGS. 6-8 and more particularly FIG. 7, in a first stage 28, in various aspects, a probe 2B with multiple filters (22A and 22B) at least partially provided in the sleeve housing 24 may be inserted in a reactor vessel 64, see FIG. 16, such that one filter or membrane 22A is in contact with fluid in the reactor vessel 64, see FIG. 16, and one or more other filters 22B are prevented from contacting the fluid by the sleeve housing 24 and/or other components (e.g., O-rings 30) of the probe 2B and/or sleeve housing 24 that cover or help isolate the one or more other filters (22, 22A, 22B) from the fluid. In various embodiments, the sleeve 24 and/or other components (e.g., O-rings 30) that cover or help isolate the one or more other filters 22A from the fluid prevent the other filters 22B from being compromised by material in the fluid (e.g., by binding substances or being lodged with debris onto the outer surface 12 of the filter).

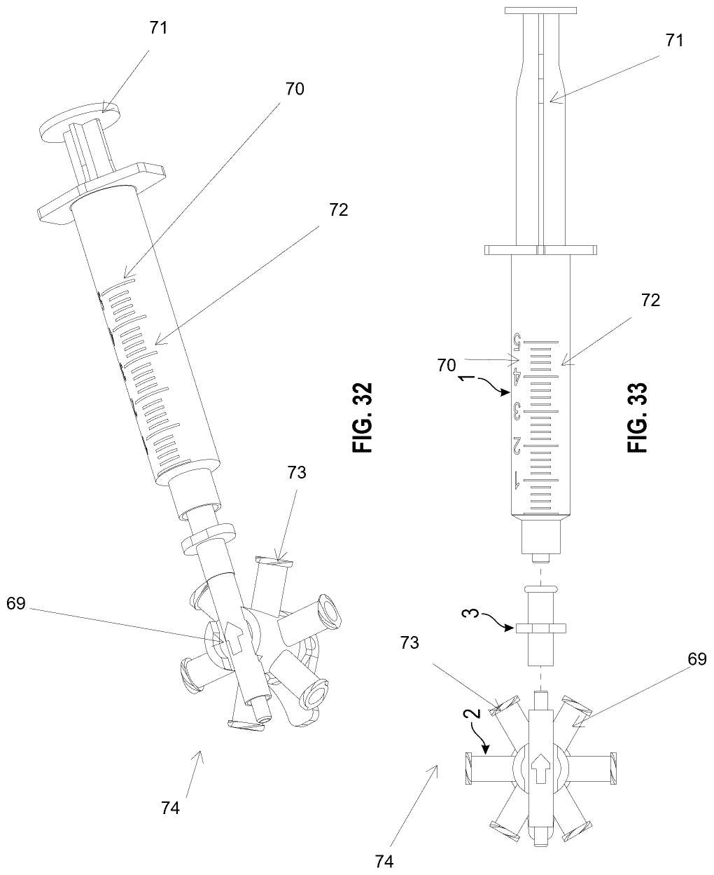

This sleeve 24 effectively extends the effectiveness of the probe 2B during the process. During a process, filters 26 can be compromised when in contact with the reactor vessel 64, see FIG. 16, fluids, even if the fluid is not being pulled through the filter 22. Fluid flows, passes and/or is pulled through one filter 22A into an inner diameter or conduit 4 of the probe 2B. While FIGS. 6-8 illustrate a single inner diameter or conduit 4 common to all filters 22, it will be appreciated that each filter (22A, 22B) could lead to an independent inner diameter, conduit or line 4. In the case that each filter (22A, 22B) has its own independent line 4, each line 4 coming from the probe 2B may be connected to a multi-position valve 69, see FIG. 32, which valve can be disposable.

In various embodiments, as the process of filtering fluid progresses and the first filter 22A becomes clogged or compromised, or as desired, the probe is slidably repositioned to a second stage 32 and a new filter 22B is exposed by moving the next filter 22B from the sleeve 24 and exposing it to the fluid. This method is repeated with multiple filters 22 as each preceding filter 22 becomes clogged or compromised.

It should be appreciated that the stages of movement of the probe 2B and/or filters 22 relative to the housing may be done manually or may be automated.

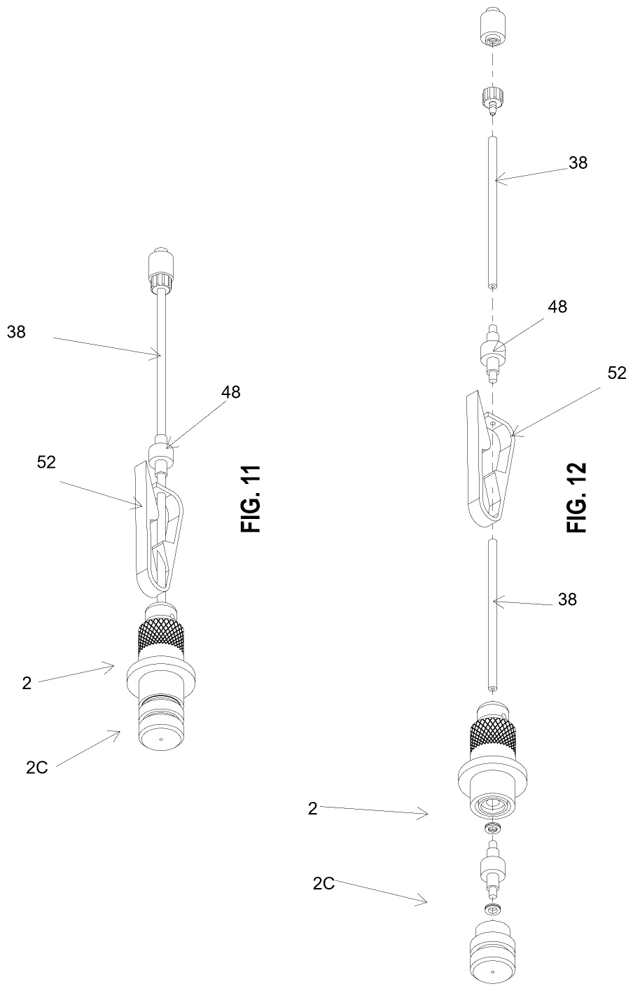

With attention to FIGS. 9 to 12, a third aspect of the disposable sampling probe 2C is illustrated. The third aspect of the disposable sampling probe 2C is a two piece construction have a base 34 and a probe head 36 with the probe head attached to the base 34. The base 34 provides for the first end 6 on which a tube 38 is attached. The base 34 has a base shell 40 which defines a base cavity 42. The probe head 36 provides for the opposite second end 8. Proximate to the second end is a o-ring groove 23. The probe head 36 has a head shell 44 which defines a head cavity 46. Housed at least partially in the base cavity 42 and a partially in the head cavity 46 is a check valve 48. Buttressing and sealably connecting the check valve 48 within the combined cavity of the base cavity 42 and a head cavity 46 are seals 50. The disposable valve 2C operates by receiving fluid through the receiving through-hole 25. The check valve 48 hindering the return of fluid into the reactor vessel 64, see FIG. 16. The fluid proceeds through the check valve and out the first end into the tube 38. As illustrated in FIGS. 11 and 12, a second check valve may be positioned along the line, and preferably proximate to the disposable valve 2C. A pinch-off valve 52 is in fluid connection with the line proximate to the check valve 48 along the tube 38. The apparatus of FIG. 11 is sterilized in manners described in this application prior to use.

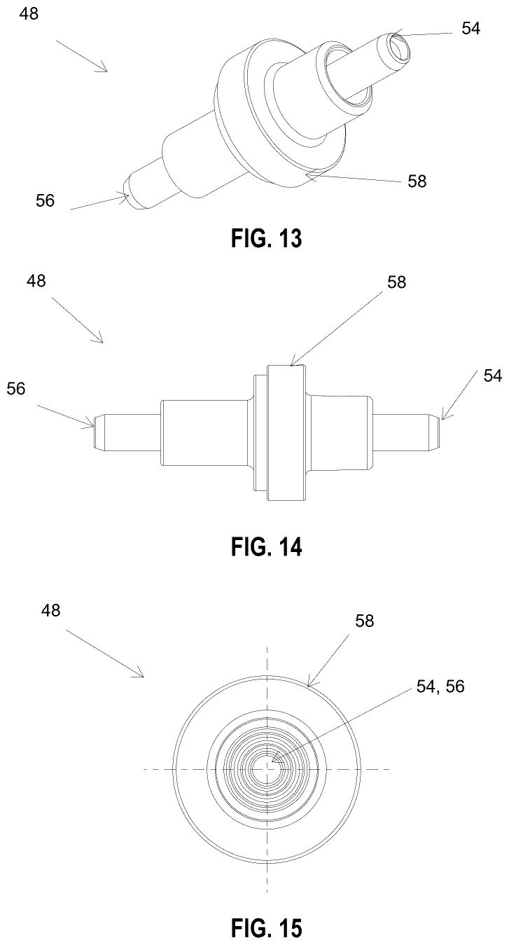

With attention to FIGS. 13 to 15, the check valve 48 is illustrated. The check valve 48 has a valve first end 54 and valve second end 56 and a valve body 58 in fluid connection to define the valve 48. The check valve 48 hinders two-way flow of the fluid which is important to limit contamination of fluid in various aspects of the system to be defined. The design of the check valve may vary retain the same function.

With attention to FIGS. 17 to 18, the fourth aspect of the disposable sampling probe 2D (see FIG. 17), and the fifth aspect of the disposable sampling probe 2E (see FIG. 18) are illustrated. Each of the fourth aspect of the disposable sampling probe 2D and the fifth aspect of the disposable sampling probe 2E provide for a combination probe and/or dip tube (FIGS. 1 to 5) is illustrated. In various embodiments, the probe or dip-tube (2D, 2E) defines a first internal conduit or diameter 4A that extends between opposing ends of the probe or dip-tube (6, 8) to first inlet (not illustrated in the figures) and a filter 22 is provided over the first inlet and may be used to pull or otherwise gather a filter sample. In various embodiments, the first internal conduit or diameter 4A extends from the first inlet (not illustrated in the figures) to a first outlet 14A provided on one opposing end 8. As shown in the Figures, the first internal conduit or diameter 4A is offset from the longitudinal center of the probe or dip-tube. In various embodiments, the probe or dip-tube (2D, 2E) defines a second internal conduit or diameter 4B that extends between opposing ends (6, 8) of the probe or dip-tube (2D, 2E) from a second outlet 14B to a second inlet (60, 10). In various embodiments, the second internal conduit or diameter extends 4B from the second inlet 14B to the second outlet (60, 10) provided on one opposing end 8. Similar to the second aspect of the probe 2B, multiple filters 22 may be applied with subsequent filters 22 being sealably contained prior to the respective filter's application.

Referring more specifically to FIG. 17, in various embodiments, the second inlet 60 is defined in an end of the probe or dip tube 2D opposing the end 6 of the dip tube 2D defining the outlet 14B and it is in fluid communication with the second internal conduit or diameter 4B. In various aspects, and referring now to FIG. 18, the second inlet 10 is defined in an outer surface 12 or outer diameter of a side 12 of the probe or dip-tube 2E that is in fluid communication with the second internal conduit or diameter 4B. As shown in FIGS. 17 and 18, in various aspects, the second internal conduit or diameter 4B is offset from the longitudinal center of the probe or dip-tube (2D, 2,E) and away from the side 12 of the probe or dip-tube (2D, 2E) defining the inlet (60, 10). In various embodiments, the second inlet 10 is partially defined by a shroud 16 provided at a bottom of the second inlet and/or the angled side wall 20 extending at the acute angle relative to the second internal conduit or diameter. The position of the second inlet 10 in the side 12 of the probe 2E (rather than in the end 8 opposing the end 6 coupled to the outlet 14B as illustrated in FIG. 17), the shroud 16 and/or the acutely angled side wall 20, helps prevent process air and/or bubbles or the like from entering the second internal diameter 4B of the probe or dip-tube 2E. As a result, more fluid relative to air is removable from the reactor vessel 64, see FIG. 16. In various embodiments, unfiltered fluid is removable from the reactor vessel 64, see FIG. 16, through the second inlet (60, 10).

Referring again to FIGS. 17-18, in various embodiments, the probe or dip tube (2d, 2E) has multiple independent internal diameters (4A, 4B), at least one 4A of which is fitted with a filter or multiple filters 22 and another 4B of which is not provided with a filter 22. In various embodiments, the probe (2D, 2E) has two independent inlets (60 and 10 being one type of inlet, and the second inlet is not illustrated in the figures), one for filtered fluid (not illustrated in the figures as under the filter 22) and the other (60, 10) for unfiltered fluid. In various embodiments, the probe (2D, 2E) has two independent outlets (14A, 14B) that include or are fluidly coupled to connectors for drawing the filtered and unfiltered fluid out of the reactor vessel 64, see FIG. 16. In various examples of aspects, the probe 2 allows both filtered and unfiltered fluid to be removed from a reactor vessel 64, see FIG. 16 while requiring only one vessel port 14.

With that, the disposable sampling probe 2 in the various aspects comprises: a main body 12 having a longitudinal dimension; a fluid path 4 housed in the main body 12 and operatively connected to a collection apparatus (10, 22, 60) positioned along the longitudinal dimension, with the collection apparatus being one of a filter 22 positioned on the housing and an angled inlet port 10; the fluid path 4 having an outlet 14 opposite the collection apparatus (10, 22, 60) along the longitudinal dimension; a tubing 38 fluidly connected to the outlet 14; a check valve 48 is in fluid connection to the main body 12, proximate to the outlet 14; and the disposable sampling probe 2 is positioned in one of a reactor and a process stream 64, see FIG. 16. In various aspects, the main body is a two-piece main body 22 and 24, and 34 and 36. The check valve 48 is positioned in the main body 12. A second check valve 48 is operatively positioned along the tubing 38 proximate to the outlet, and the check valve 38 and/or the second check valve 38 are positioned to operatively hinder a flow of the fluid from flowing back into one of a reactor and a process stream 64, see FIG. 16. Further, the disposable sampling probe 2 is sterilized through one or more of radiation, chemical sterilization, stream sterilization, or in-situ sterilization. A second fluid path (4A, 4B) is housed in the main body 12 and extending the main body 12 along the longitudinal dimension, and the second collection apparatus (10, 22, 60) is operatively connected to the second fluid path (4A, 4B) and a second outlet (14A, 14B) opposite the collection apparatus (10, 22, 60) along the longitudinal dimension. In certain aspects, a third check valve 48 is operatively positioned in the main body 12 along the second fluid path (4A, 4B) and a fourth check valve 48 operatively positioned along a second tubing (4A, 4B) operatively connected to the second outlet (14A, 14B). The angled inlet port 10 is positioned at a 45 degree angle on a side of the main body along the longitudinal dimension, with the angled inlet port being a hinderance to inclusion of an air or a foam in the fluid path. In certain aspects, the main body 12 is slidably positioned in the probe sleave 24 that has an open end 33, and the main body 12 slidably extends beyond the open end 33 to a first position 35 for an exposure of a first collection apparatus 22A. In certain aspects, the main body 12 is slidably extendable to a second position 37 for an exposure of a second collection apparatus 22B, and the second collection apparatus 22B is sealably removed from the fluid prior to the second position 37. A sensor (not illustrated in the figures) for measurement of one of a fluid volume and a fluid flow rate for a determination of the slidable extension to a subsequent position.

It should be appreciated, however, that the fluid may be provided into a harvest line 62, such as that illustrated in FIG. 16, of a tangential filtration, ATF, perfusion, or similar system that is connected to the vessel, reactor and a process stream, 64 being sampled. The fluid travels through a tube 38 of indeterminate length towards a hollow fiber 65 with the ATF pump 67 drawing the fluid. The harvest line 62 also for retrieval of the cellular and cellular component samples by providing a perpendicular or nearly perpendicular branch from the tubing 38 and/or hollow fiber 65 for which the cellular and cellular component samples may proceed. Thus, cellular material is not in the harvest line but instead cellular expressed proteins, which is understood proceeding forward in the process as the fluid. A fluid sample can be drawn/used from this harvest line 62 for collection or analysis.

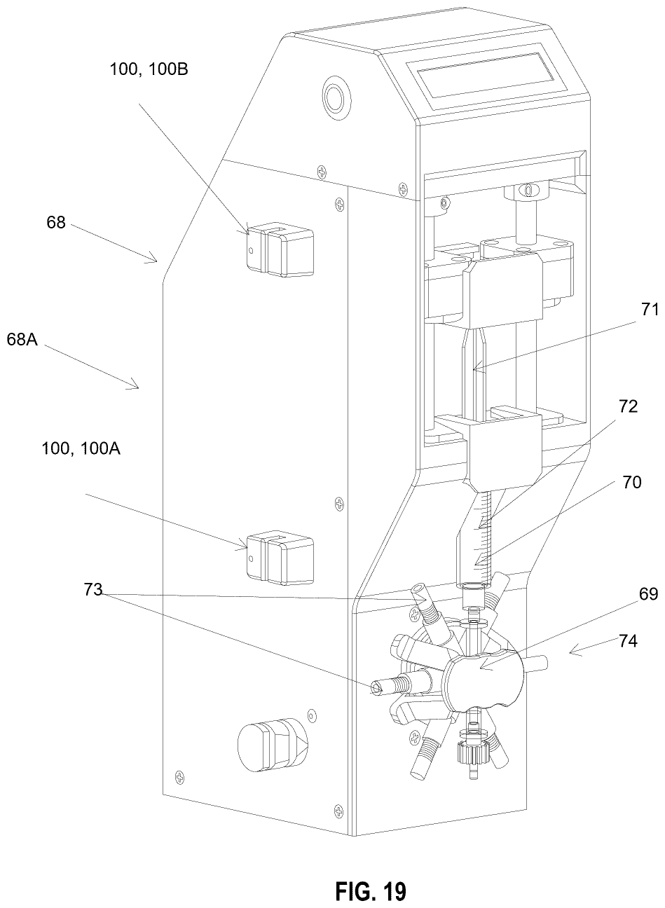

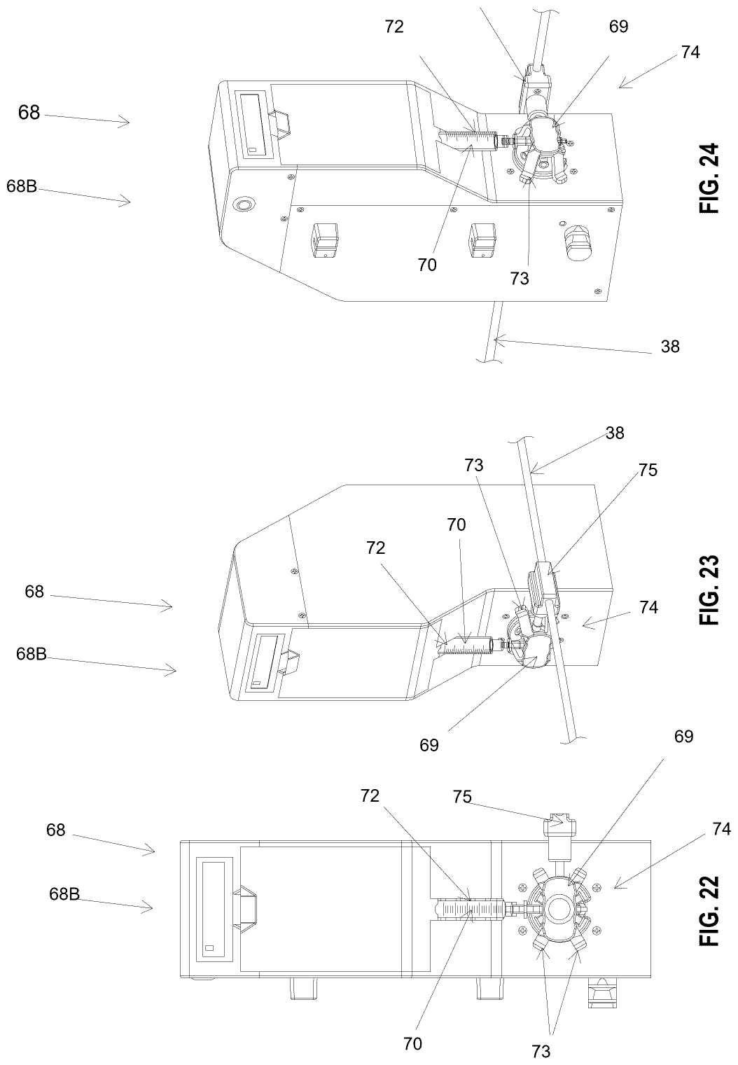

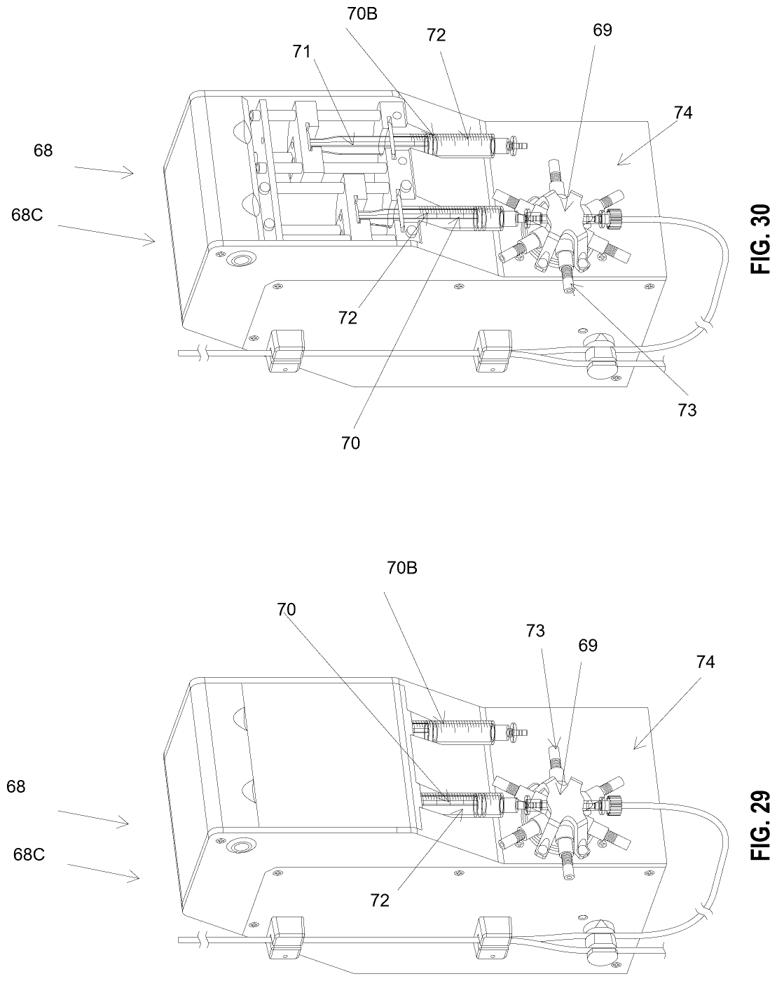

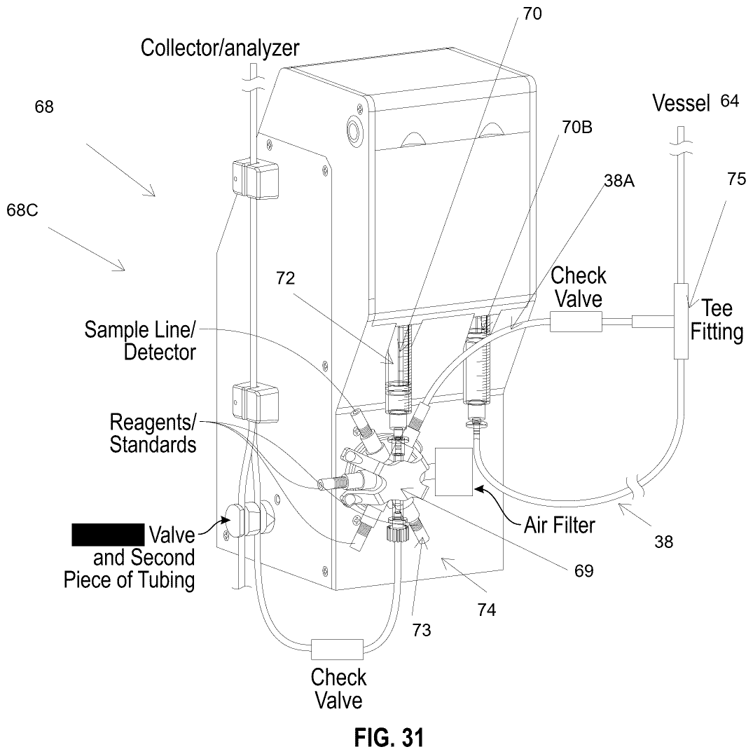

With attention to FIGS. 19 to 24 and 29 to 31, various examples of a sampling module/sampling device (e.g., a parallel sampling module) 68 of the system (e.g., system for parallel sampling) are illustrated, a first aspect of a first aspect of the sampling device 68A (see FIGS. 19 to 21), a second aspect of the sampling device 68B (see FIGS. 22 to 24), a third aspect of the sampling device 68C (see FIGS. 29 to 31). It is understood each aspect of the sampling device (68A, 68B, and 68C) incorporates and features of one or more of the aspects of the sampling devices (68A, 68B, and 68C). In various embodiments, the sampling module 68 is located next to or near a vessel 64, or process stream, stainless reactor, SUB. A sampling module 68 may be used independently or in combination with other sampling modules.

Referring more specifically to FIGS. 19 to 21, in various aspects, the sampling module (e.g., parallel sampling module) 68 includes at least one multi-position valve 69. In various embodiments, the multi-position valve 69 is disposable. In various aspects, the multi-position valve 69 is fitted with, drivable and/or otherwise operable by a motor (not illustrated in the figures). In various aspects, the sampling module 68 also includes a first pump (e.g., a syringe pump) 70 fitted with, drivable and/or otherwise operable by a connection to a motor (not illustrated in the figures) to move a plunger 71 of the pump 70 relative to a barrel 72, see FIG. 19. In various aspects, the first pump 70 is disposable. In various aspects, the sampling module/sampling device 68 includes multiple ports 73. While six ports are illustrated in the FIGS. 19 to 21, it will be appreciated that more or fewer ports may be utilized or included, see FIGS. 22 to 24 where the sampling device 68B has six ports, the sampling device may have two or four ports 73.

In various aspects, the system utilizes an assembly 74 including a disposable syringe 70 (or another type of disposable pump, pump head or device) that is connected to an inlet or outlet 92 on the disposable multi-position valve 69. An example assembly including a syringe 70 and multi-position valve 69 is illustrated in FIGS. 32 to 33. Referring again to FIGS. 19 to 24 and 29 to 31, in various aspects, the sampling module includes one or more drive motors (e.g., a drive motor for the syringe or pump and/or a drive motor for the multi-position valve) (not illustrated in the figures).

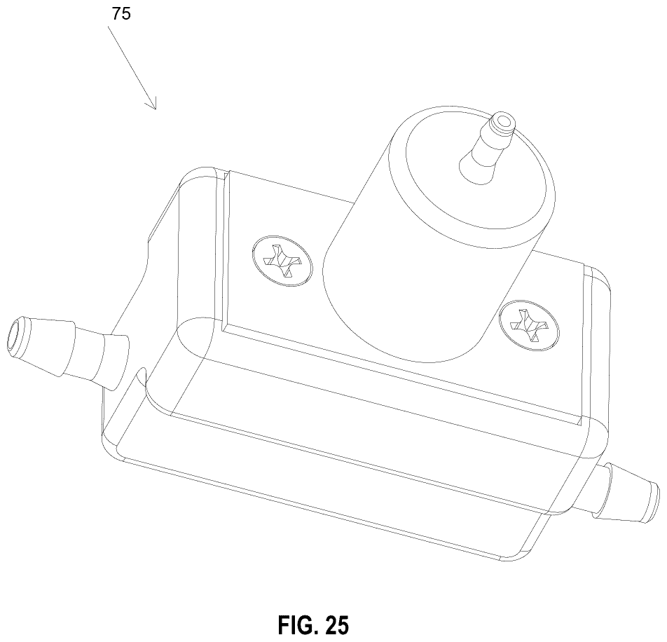

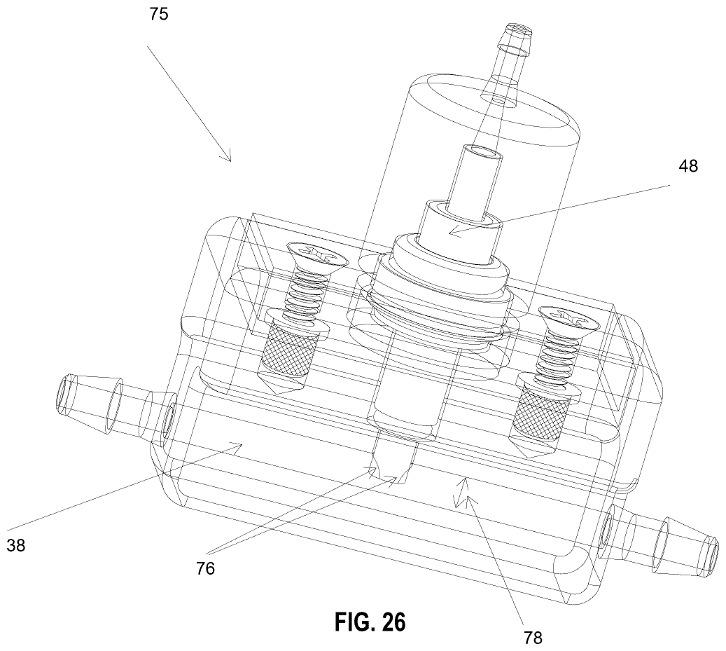

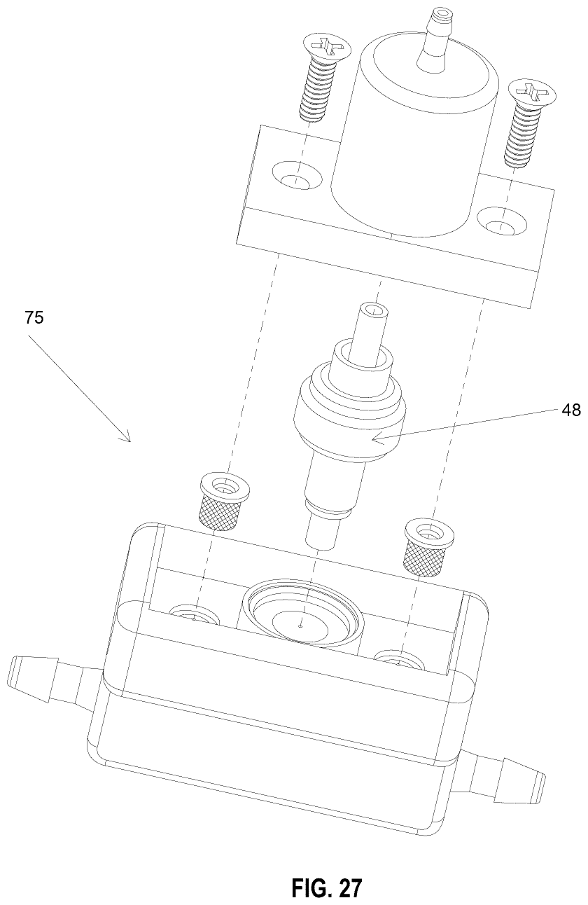

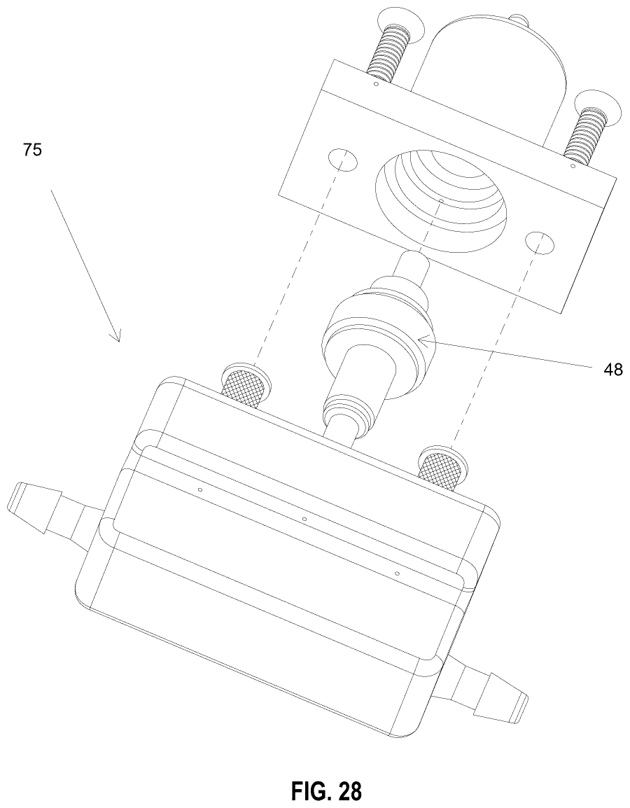

Referring more specifically to FIGS. 22 to 24, in various aspects, the sampling module/sampling device (68, 68B) will be connected or fluidly coupled to an in-line sampling tee or tee-connection 75 that is connected to a process line/stream or tube 38. In various aspects, and referring now to FIGS. 25 to 28, the in-line sampling tee 75 includes a check 48 valve to prevent flow back into the process line/stream or tube 38. In various aspects, the in-line sampling tee 75 has a recessed inlet 76 to the inner diameter 78 of the flow path to allow fluid to be taken from the middle portion of the sampling line/stream or tube 38. The sampling tee 75 may be disposable and may be manufactured to handle any size pipe or tube 38.

With attention to FIGS. 19 to 24 and 29 to 31, in various aspects, the sampling module/sampling device 68 includes a processor (not illustrated in the figures) that may be programmed to control and/or automate the module and 68 its components (the components for example being multi-position valve 69, the syringe/pump 70, and a motor (not illustrated in the figures)). In various aspects, the module 68 includes an ethernet port (not illustrated in the figures) to allow the module 68 to be controlled by a central device or communicate with other systems/modules.

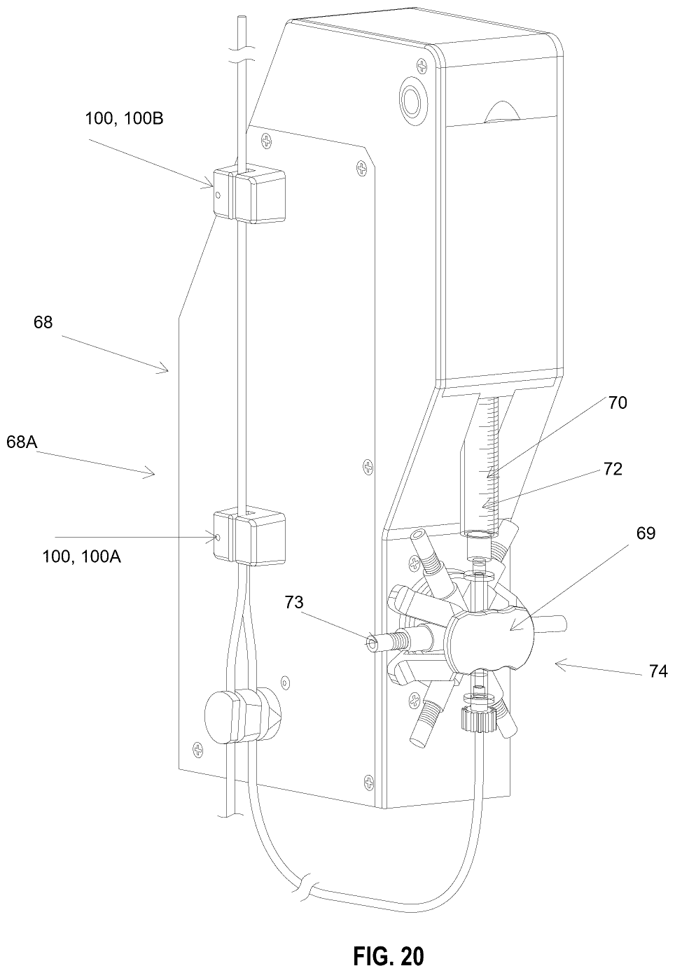

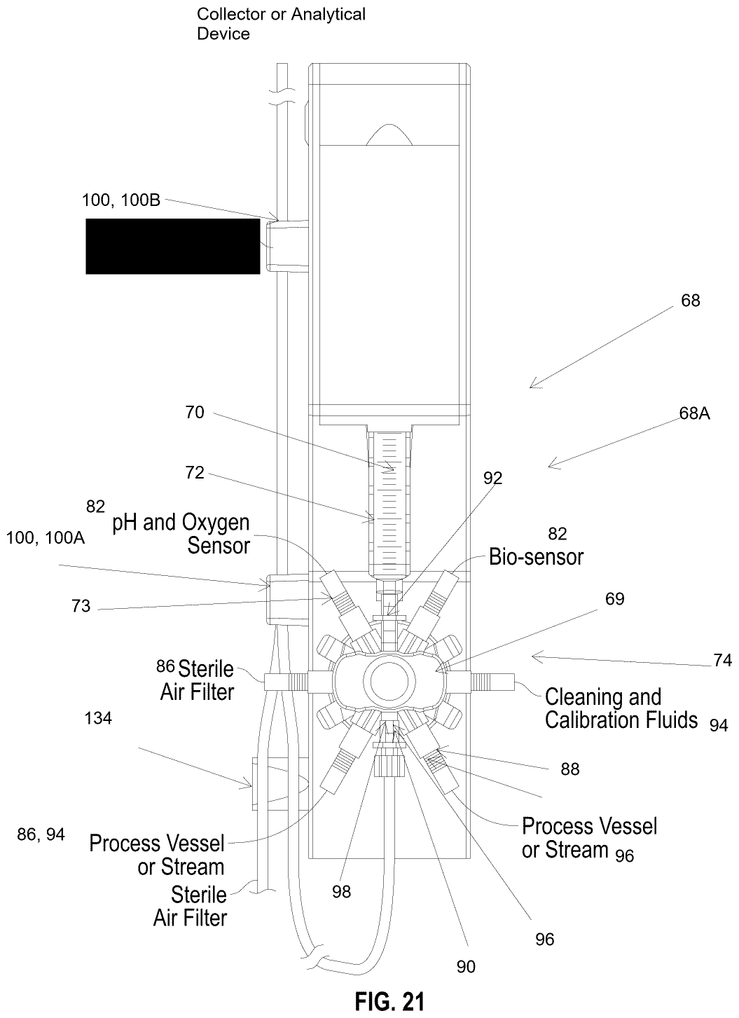

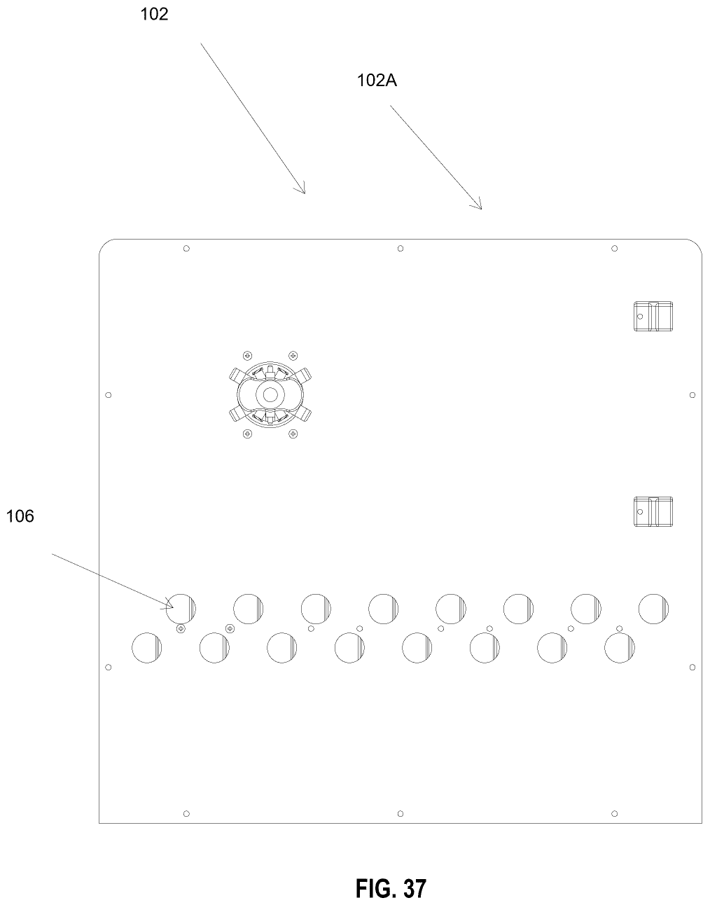

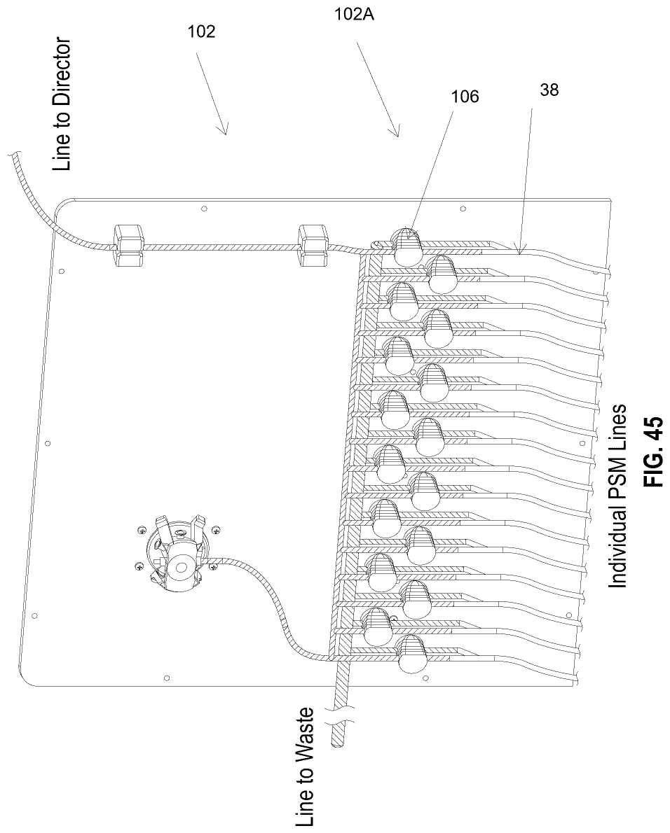

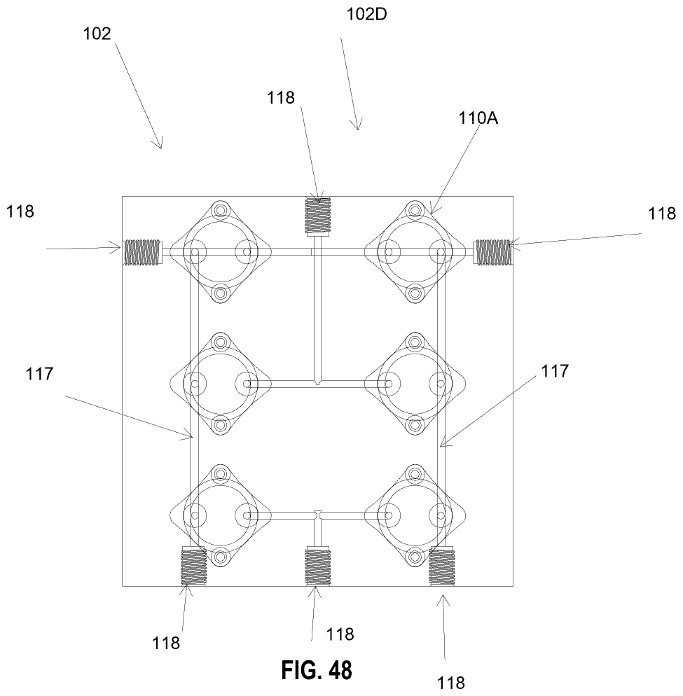

With attention to FIGS. 20 to 21, a three-way valve 134 (or 2 way valve not depicted) having a normally open (NO) port/location, normally closed (NC) port/location 88 and a common port (CP) 90. In various embodiments, the port is connected to an air filter (e.g., a sterile air filter to help maintain sterility) 86. A segment of tubing connects (e.g., fluidly couples) the NC port to a Delivery Port (DP) on the multi-position valve. The connection to the CP (90) depends on the device with which the sampling module is interfacing. In the case of an analyzer, for example, a segment of tubing 38 connects (e.g., fluidly couples) the CP (90) with an input port or interface port of the analyzer. With a central processing/collection station (CP/CS) 102, see FIGS. 37-50, such as the CP/CS aspects illustrated in FIGS. 29-31, as another example, a segment of tubing connects (e.g., fluidly couples) the CP to an NO port of a corresponding 3-way valve on the CP/CS. In the case of the sterile bag manifold apparatus (SBM) such as the SBM embodiments illustrated in FIGS. 33-35, as another example, the CP 90 is connected (e.g., fluidly coupled) with a segment of tubing to the input port of a multi-position valve on the SBM and multiple fluid sensors.

It will be appreciated, however, that the sampling module/sampling device 68 need not include the three-way valve.

In various embodiments, and referring again to FIGS. 20 to 21, the multi-position valve 69 of the sampling module 68 has independent ports and additional multi-position valves may be added in series. In various embodiments, the multi-position valve 69 of the sampling module 68 includes the following: a connection to the syringe 92, multiple ports 73 that deliver fluid to a collector or measuring device or analyzer 82, multiple ports 73 that connect to reagents, buffers, calibration standards or cleaning fluids (86, 94), a port 73 with an air filter 86; two fluid ports that connect to vessels and/or process streams 96, multiple ports that are connected to detectors/probes/devices (e.g., a biochemistry chip/analyzer, pH probe, dissolved oxygen probe, capacitance probe, conductivity probe, etc.) 82 that can be calibrated and hydrated using the calibration standards/reagents from the other ports of the multi-position valve 69; and a delivery port (DP) 98 that delivers the fluid to a collector or analytical device.

While the first pump 70 is illustrated as a syringe pump 70, in various aspects the first pump 70 is a peristaltic or displacement pump. In various aspects, the first pump is located between the delivery port (DP) and a collector, analytical device, CP/CS 102,, see FIGS. 37-50, SBM or similar device.

In operation in various aspects, the vessel fluid coming from via the delivery port (DP) moves through two fluid sensors (100, 100A, 100B), fluid sensor 1 (FS1) 100A and fluid sensor 2 (FS2) 100B. In various aspects, the distance between FS1 100A and FS2 100B is a fixed value, and the internal volume of the tubing between FS1 100A and FS2 100B is a fixed value (V1). In various aspects, these two fluid sensors (100A, 100B) sense that fluid was successfully withdrawn and may be used to calculate the volume or approximate volume of fluid that was taken from the vessel 64, see FIG. 16. In various aspects, the volume of fluid taken is calculated or approximated by detecting the fluid at FS1 100A, documenting the time when the fluid is detected (T0), detecting fluid at FS2 100B, documenting this time (T1), calculating the Flowrate (FR) (using the following equation [V1/(T1−T2)]), documenting the time when air is detected at FS1 (T3) and calculating the volume (V) being delivered (by subtracting T3 from T1 and multiplying this value by FR). This process may be repeated at the delivery device, if there is one, to confirm the volume of the fluid being delivered to a collector or other device.

With attention to FIGS. 29 to 31, the sampling module in various embodiments includes a second pump (e.g., syringe pump or syringe) 70B. In various aspects, the second pump 70B is disposable. In various aspects, the second pump 70B is fitted with, drivable and/or otherwise operable by a connection to a motor to move a plunger of the second pump 71 relative to a barrel 72. In various embodiments, a segment of tubing 38 connects (e.g., sterilely connects) the second pump 70B to a port on a vessel 64 that may have a filtration device (e.g., a filtration probe 2). In various embodiments, the segment of tubing has a T-connection 75. In various embodiments, one of the fluid ports 73 on the multi-position valve connected with the first syringe connects (e.g., fluidly) to this T-connection 75.

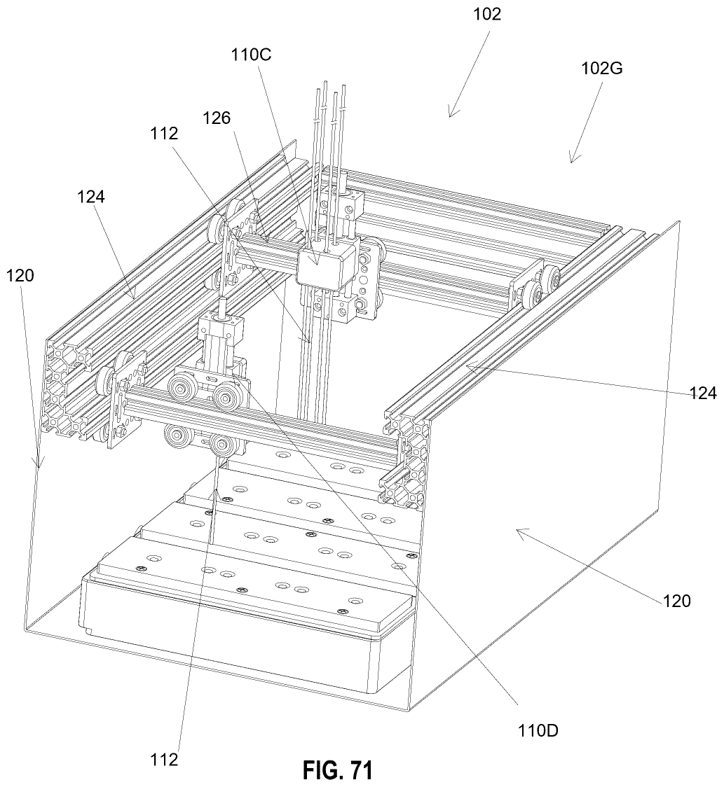

With attention to FIGS. 1 to 71, in operation according to various examples of aspects, the second pump 70B removes fluid from the vessel or stream 64, and holds or retains the removed fluid. In various aspects, the second pump 70B purges the fluid line 38 coming from the vessel 64. In various aspects, the first pump 70 draws the fluid from the line connected to the T-connector 75. Once the first pump 70 draws the required volume of fluid, in various aspects, the second pump 70B pushes the fluid it was holding/withdrew from the vessel 64 back into the vessel 64. If a filtration device is used, this action helps back flush and/or clean the filter. In various embodiments, sterility is maintained during the process.

In various aspects, the fluid path, and components included in that fluid path, for the sampling modules 68 disclosed herein may be sterile and disposable.

In various aspects, multiple sampling modules 68 draw fluid from one or more vessels 64 simultaneously for parallel sampling. In various embodiments, the fluid from the vessel(s) is provided (e.g., by a sampling module 68) to a CP/CS 102, see FIGS. 37-50 and 69-71.

In various aspects, one or more delivery lines 38 from multiple sampling modules draw fluid from multiple vessels 64 simultaneously for parallel sampling. In various aspects, the fluid from the vessels 64 are provided to a CP/CS 102, see FIGS. 37-50 and 69-71. In various aspects, the delivery lines 38 from the vessels 64 are connected to an arm on the CP/CS 102, see FIGS. 37-50 and 69-71. In various aspects, the arm on the CP/CS 102, see FIGS. 37-50 and 69-71, can move in one direction (e.g., along one axis or plane). In various aspects, the arm on the CP/CS 102, see FIGS. 37-50 and 69-71 can move in multiple directions. In various aspects, the delivery lines 38 mounted to the arm on the CP/CS 102, see FIGS. 37-50 and 69-71, provide fluid and cleaning fluids to a common reservoir on the CP/CS 102, see FIGS. 37-50 and 69-71. In various aspects, the arm on the CP/CS 102, see FIGS. 37-50 and 69-71, to which the delivery lines coming from the sampling modules are coupled moves over a set of vials or over a set of wells in a microtiter plate. In various aspects, the fluids from the sampling modules are provided in one or more of the vials or wells of the microtiter plate. In various embodiments, the arm on the CP/CS 102, see FIGS. 37-50 and 69-71, then moves back to the common reservoir. In various aspects, the sampling modules now clean their individual lines and deposit this cleaning fluid into the common reservoir.

In various aspects, in operation, the sampling modules 68 first purge remaining sample from its respective vessel 64 and provide the remaining sample into the common reservoir on the CP/CS 102, see FIGS. 37-50 and 69-71. In various aspects, each sampling module 68 then harvests a new sample from its respective vessel 64 and signals the CP/CS 102, see FIGS. 37-50 and 69-71, that the new sample is ready for delivery. In various aspects, once the sampling modules have all notified the CP/CS 102, see FIGS. 37-50, and 69-71 of the new samples awaiting delivery, the CP/CS 102, see FIGS. 37-50 and 69-71, moves the arm so that the delivery lines coupled thereto are positioned so that the delivery lines can deliver the new samples to the set of vials or set of wells in the microtiter plate. In various embodiments, the CP/CS 102, see FIGS. 37-50 and 69-71, then signals the sampling modules 68 to turn on respective pumps associated therewith to provide the samples into the vials and/or microtiter wells. In various embodiments, once the CP/CS 102, see FIGS. 37-50 and 69-71, determines or is signaled that the samples have been delivered, the CP/CS 102, see FIGS. 37-50 and 69-71, then returns the arm to a position so that the delivery lines can deliver to the common reservoir and the CP/CS 102, see FIGS. 37-50 and 69-71, then signals the sampling modules to purge remaining sample from its respective vessel 64 and provide the remaining sample into the common reservoir on the CP/CS 102, see FIGS. 37-50 and 69-71, and/or clean the delivery lines in preparation for additional sampling.

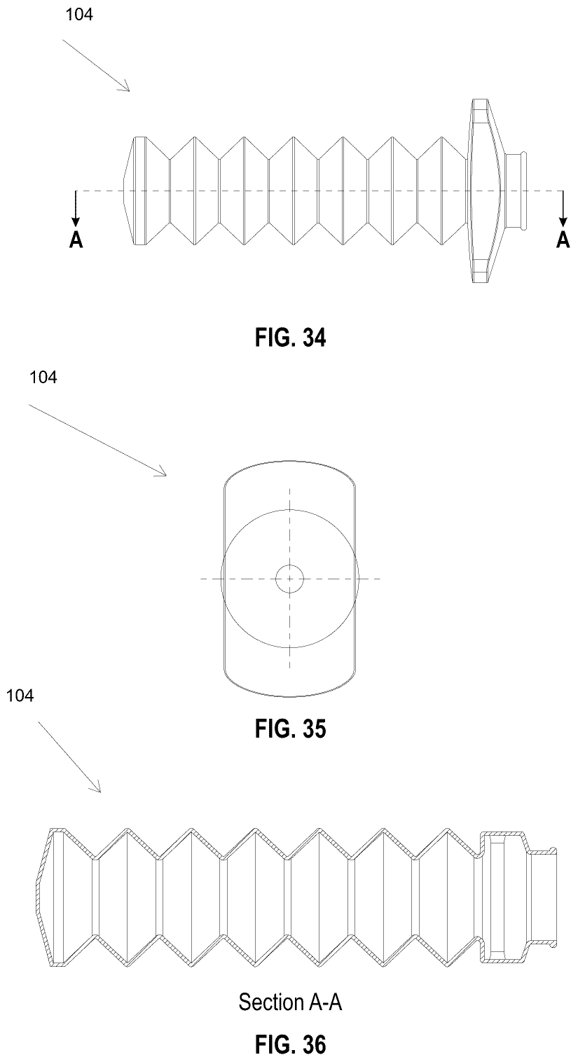

With attention to FIGS. 34 to 36, in various examples of aspects, a syringe cover, sleeve or bellows 104 is illustrated. In various embodiments, the syringe cover, sleeve, or bellows 104 covers the syringe(s) 70 of the sampling module 68, see FIGS. 19 to 24 and 29 to 31. In various embodiments, the syringe cover, sleeve or bellows 104 helps prevent the syringe 70, see FIGS. 19 to 24 and 29 to 31, from taking in or pulling air and/or helps maintain syringe 70, see FIGS. 19 to 24 and 29 to 31, sterility.

With that, as illustrated in FIGS. 1-71, the disposable syringe valve assembly 74 has the following: a disposable syringe 70, a disposable valve 69, and a motor housing; the disposable valve 69 has a plurality of ports 73 about a perimeter of the disposable valve 69; the disposable valve 69 has an adjustable dial 104 between each of the plurality of ports, with adjustable dial 104 allowing for a movement of fluid to a port 73 of the plurality of ports; the disposable syringe 70 is removably attached to an inlet of the disposable valve, it is understood an inlet may be a port 73; the motor housing operatively connected to one or more of the disposable valve and the disposable syringe to provide for a withdrawal of fluid from the disposable syringe; and a second port 73 of the plurality of port removes the fluid to one or more of a collector and an analyzer.

Aspects of the syringe valve assembly 74 have: one or more of a sensor and a probe (not illustrated in the figures) removably attached to a third port 73 of the plurality of ports, a fourth port 73 of the plurality of ports, a fifth port 73 of the plurality of ports, and a sixth port 73 of the plurality of ports for a measurement of a substance within the fluid; the disposable syringe valve assembly 74 has a port 73 allowing for portions of the fluid positioned in the disposable syringe 70 for the movement of the fluid to multiple ports 73 of the plurality of ports. removable attachment of one or more or a sterile bag or a sterile vial at one or more ports of the plurality of ports; one of a reactor and a process stream 64, see FIG. 16, removably attached to a port 73 of the plurality of ports removably for a receipt of the fluid; one of a second reactor and a second process stream 64 removably attached to a port 73 of the plurality of ports for a receipt of the fluid; a port 73 of the plurality of ports has a calibration of one or more of the sensor and the probe 2; a port of the plurality of ports having a cleaning of one or more of the sensor and the probe 2; the second port 73 of the plurality of ports removes the fluid to one or more of a collector and an analyzer having a cleaning; and the disposable syringe 70 is a displacement pump.

With that, as illustrated in FIGS. 1-71, the sampling device 68 comprises: a disposable syringe 70, a disposable valve 69, and a motor housing; the disposable valve has a plurality of ports 73c about a perimeter of the disposable valve 69; the disposable valve has an adjustable dial 104 between each of the plurality of ports 73, with adjustable dial allowing for a movement of fluid to a port of the plurality of ports; the disposable syringe 70 is removably attached to a port 73 of the plurality of ports; a motor housing is operatively connected to one or more of the disposable valve 69 and the disposable syringe 70 to provide for a withdrawal of fluid from the disposable syringe 70; and a second port 73 of the plurality of ports for a removal of the fluid to one or more of a collector and an analyzer.

Aspects of the sampling device 68 have: motor housing is a plurality of motor housings; one or more of a sensor and a probe removable attached to a third port 73 of the plurality of ports, a fourth port 73 of the plurality of ports, a fifth port 73 of the plurality of ports, and a sixth port 73 of the plurality of ports for a measurement of a substance within the fluid; the disposable valve 69 allows for portions of the fluid positioned in the disposable syringe 70 to move to multiple ports of the plurality of ports; removable attachment of one or more or a sterile bag or a sterile vial at one or more ports 73 of the plurality of ports; one of a reactor and a process stream 64 removably attached to a port 73 of the plurality of ports removably for a receipt of the fluid; one of a second reactor and a second process stream 64 removably attached to a port 73 of the plurality of ports for a receipt of the fluid; a port of the plurality of ports has a calibration of one or more of the sensor and the probe; a port of the plurality of ports cleans one or more of the sensor and the probe; the second port of the plurality of ports removes the fluid to one or more of a collector and an analyzer having a cleaning; a pinch valve is included; a second disposable syringe 70 with tubing 38 operatively connected to one of the reactor and the process stream 64, with the disposable syringe 70 and the second disposable syringe 70 operatively removing the fluid from one of the reactor and the process stream 64; a second motor housing is operatively connected to the second disposable syringe; the second disposable syringe 70 is operatively returning a portion of the fluid to one of the reactor and the process stream 64; the portion of the fluid operatively removes debris from one of a filtration probe and a filtration device; one or more of a sample port, a filtration probe and a filtration device are in fluid connection with one of the reactor and the process stream 64; a tee-connection 75 is in fluid connection to a port 73 of the plurality of ports, with the tee-connection 75 being in fluid connection with one of the reactor and the process stream 64; a check valve 48 is installed on a tubing in operative connection with the tee-connection 75 and the disposable syringe 70 to hinder a reverse flow of the fluid; a second disposable valve 69 is provided; a first fluid sensor and a second fluid sensor with the first fluid sensor a predetermined distance from the second fluid sensor, and the first fluid sensor is in synchronized review with the second fluid sensor to provide a measurement of an amount of the removal of the fluid.

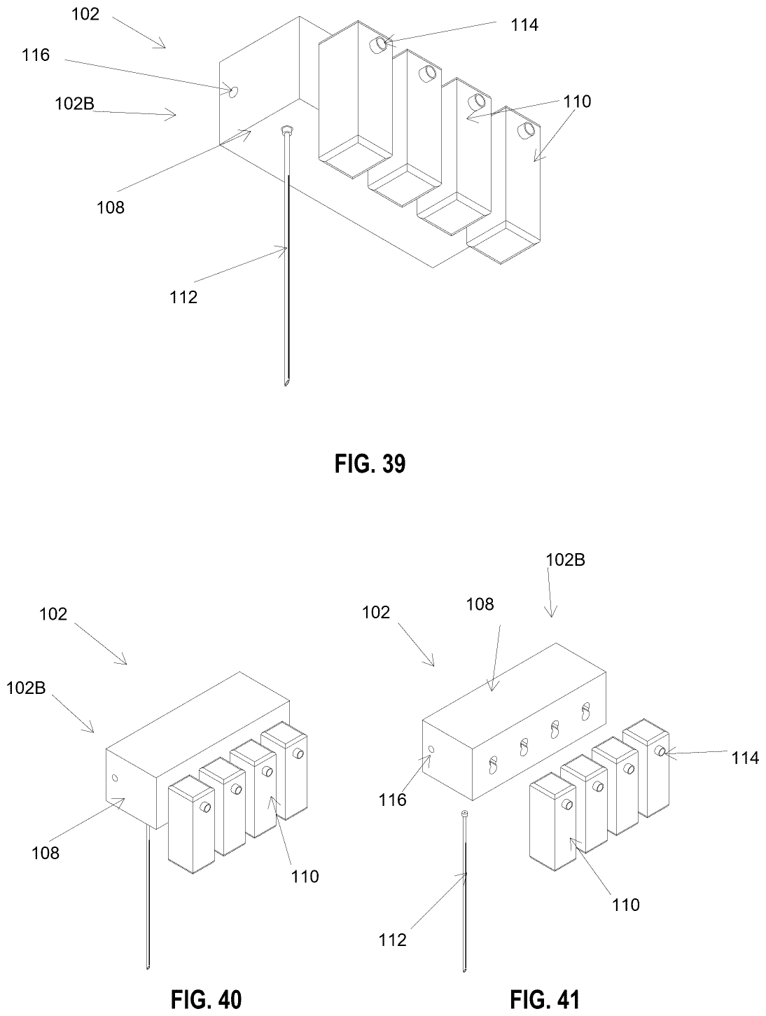

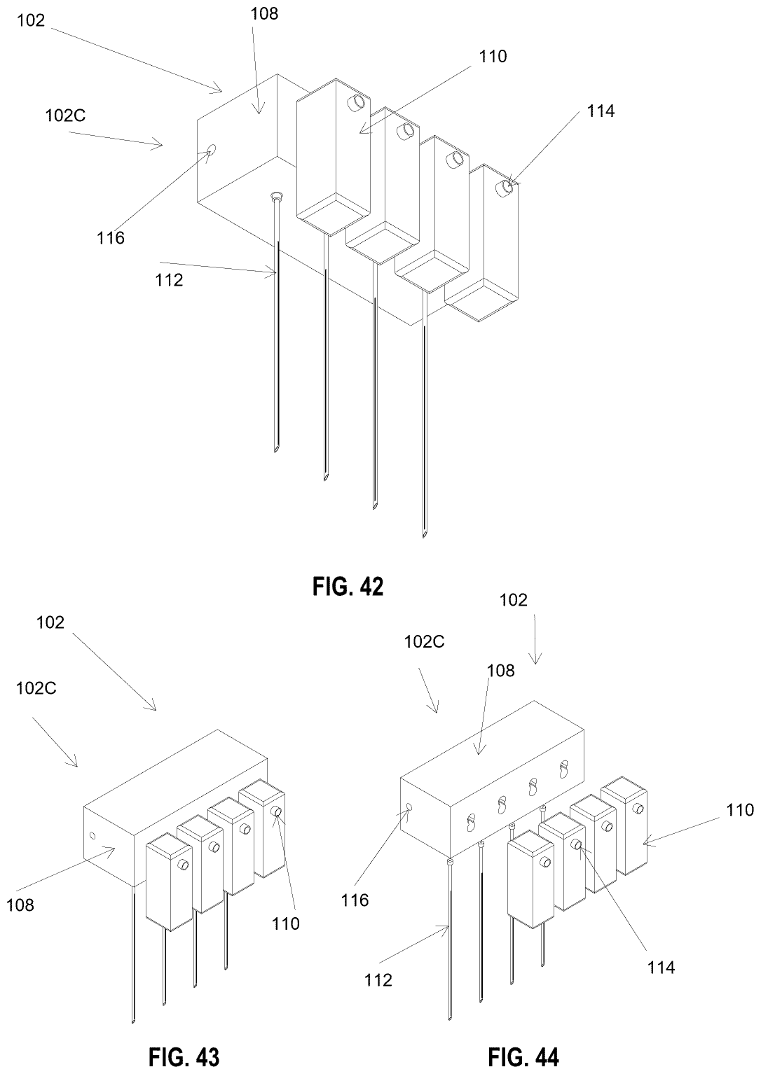

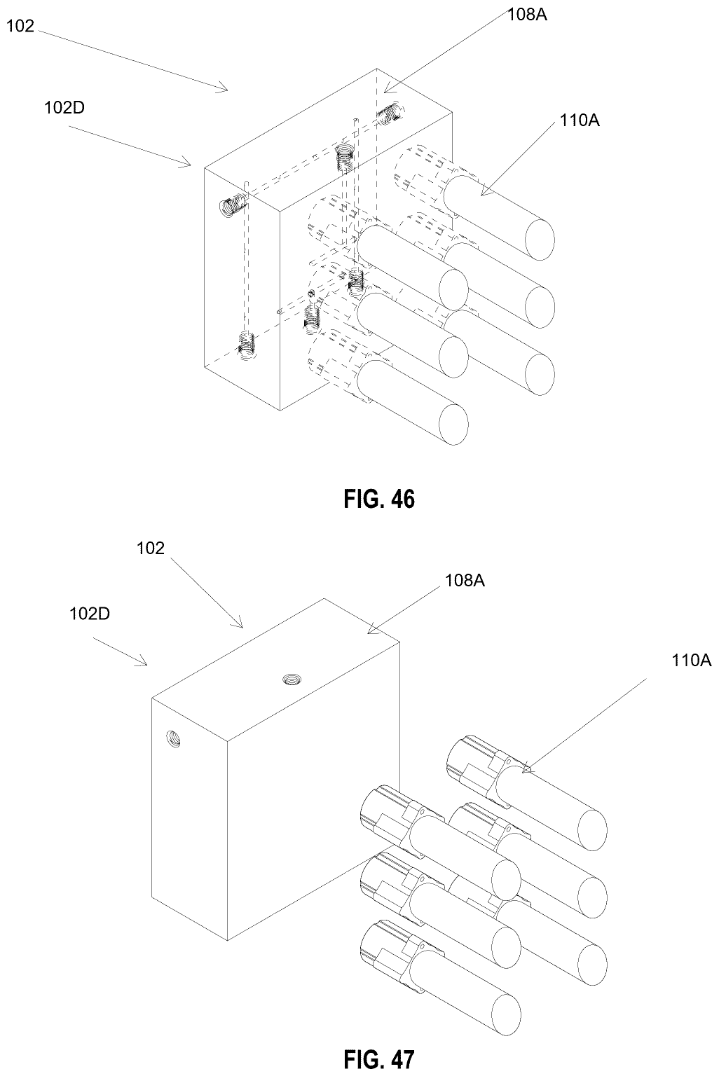

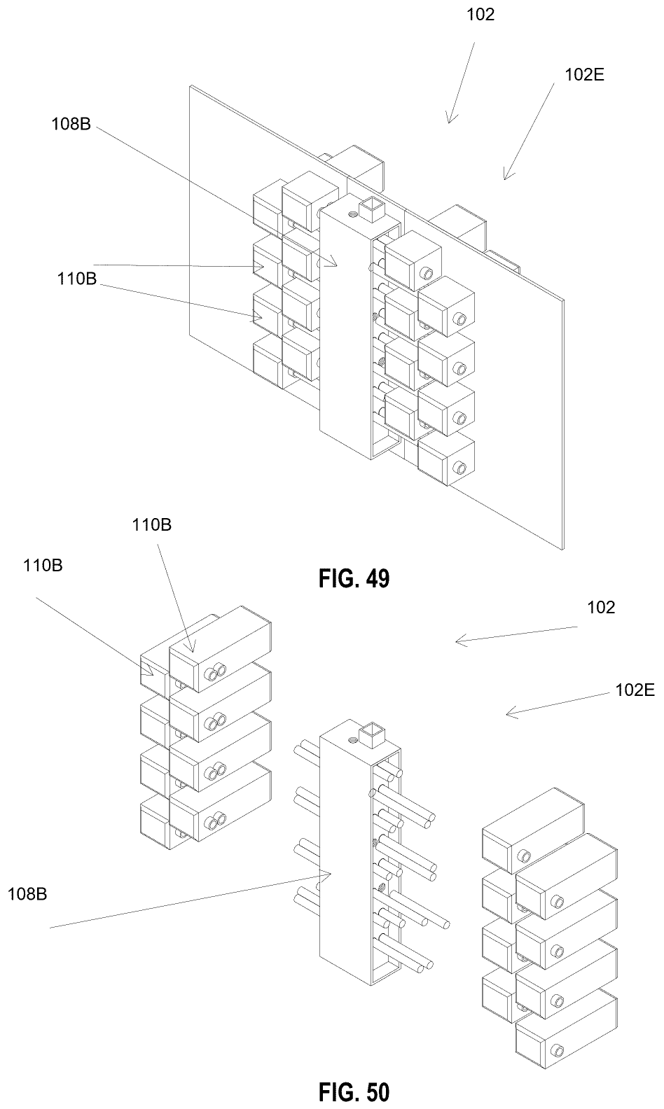

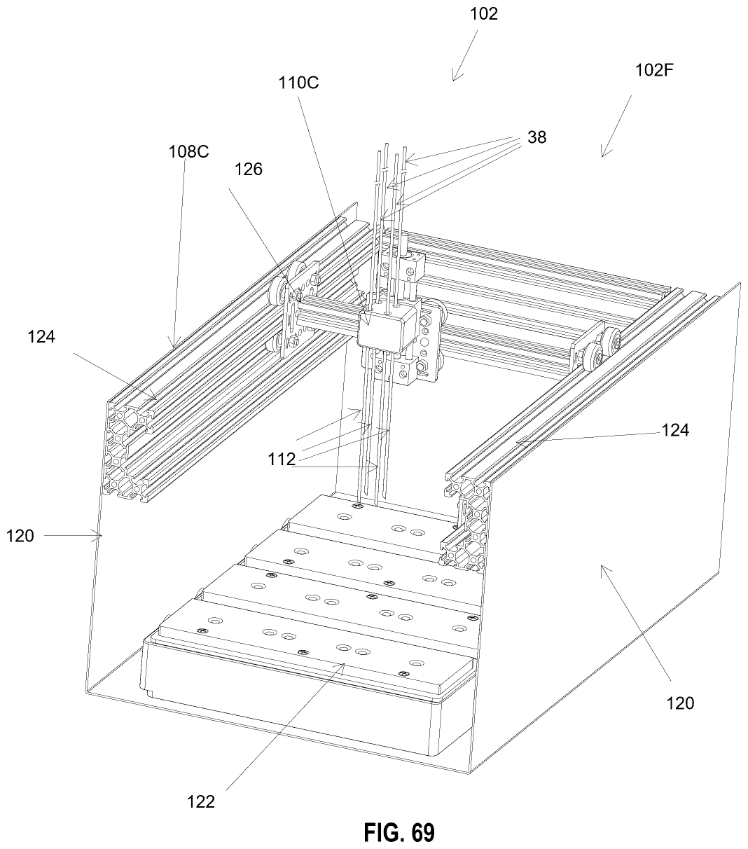

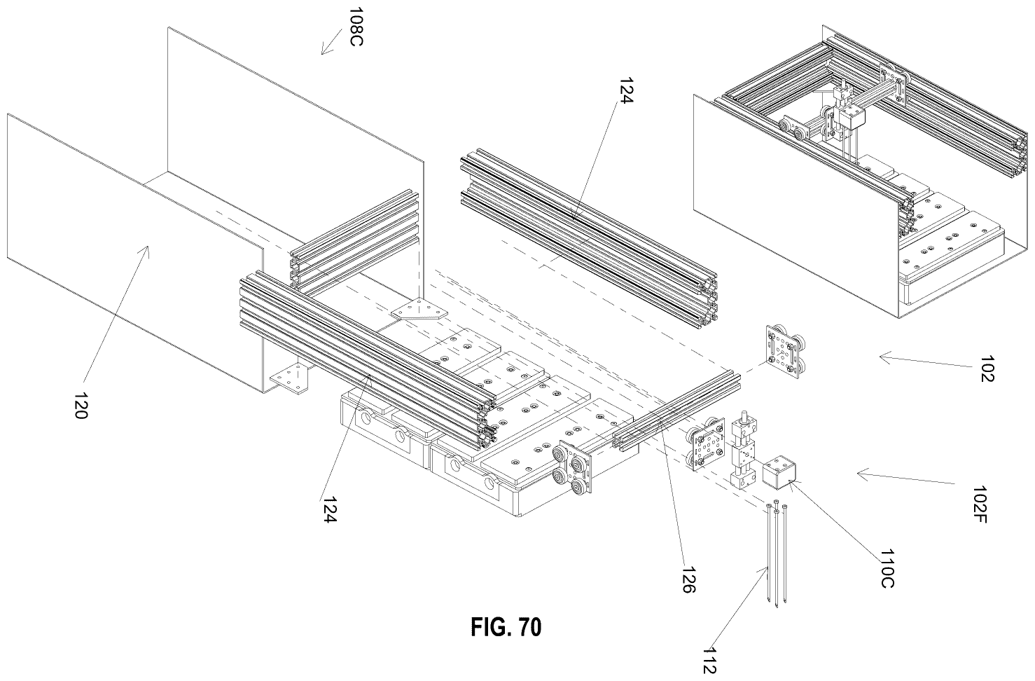

Referring now to FIGS. 37 to 50, various aspects of a CP/CS or fluid handler 102 are illustrated. In various embodiments, the system (e.g., system for parallel sampling) is provided with one of the first aspect of the CP/CS or fluid handler 102A (see FIGS. 37 to 38 and 45), a second aspect of the CP/CS or fluid handler 102B (see FIGS. 39 to 41), a third aspect of the CP/CS or fluid handler 102C (see FIGS. 42 to 44), a fourth aspect of the CP/CS or fluid handler 102D (see FIGS. 46 to 48), a fifth aspect of the CP/CS or fluid handler 102E (see FIGS. 49 to 50), a sixth aspect of the CP/CS or fluid handler 102F (see FIGS. 69 to 70), and a seventh aspect of the CP/CS or fluid handler 102G (see FIG. 71). It is understood each aspect of the disposable probe (102A, 102B, 102C, 102D, 102E, 102F, and 102G) incorporates an features of one or more of the aspects of the disposable probe (102A, 102B, 102C, 102D, 102E, 102F, and 102G) An example aspect of a CP/CS of the system (e.g., system for parallel sampling) is illustrated. In various embodiments, the CP/CS 102 includes a 3-way valve for each fluid line coming from each sampling module connected (e.g., fluidly coupled) to the CP/CS, one or more multi-position valves, a pump and fluid sensors.

In various aspects, the multi-position valve is used to selectively provide desired fluids (e.g., cleaning, buffer, dilution, or reagent fluids) into components parts of the CP/CS (e.g., the CP/CS lines). The pump may be any type of pump including peristaltic, syringe, displacement, etc.

In various embodiments, the 3-way valves are configured with a normally open (NO) port/location, normally closed (NC) port/location and a common port/location (CP). In various embodiments, a sampling module is fluidly connected to a CP/CS line connected to or associated with a valve with a segment of tubing from the DP on the disposable multi-position valve to a CP on a CP/CS 3-way valve. In various aspects, the sampling module lines coming into the CP/CS CPs can be temperature controlled (e.g., chilled) by placing their tubing in a temperature-controlled block or space. This way, in various aspects, the chemical makeup of the PSM fluids may be substantially or acceptably maintained while they are in a CP/CS queue (e.g., waiting to move or be moved or provided to an analyzer(s) or collector(s)). In various aspects, the NO on each CP/CS 3-way valve is connected with a segment of tubing to a central line that connects to a reservoir or waste bottle. In various aspects, the central line has individual ports for each associated sampling module line. In various aspects, the ports extend out of the inner wall of the common line to prevent fluid from flowing backwards or in reverse. In various aspects, the central line includes an inside chamber having a slightly downward slope so that the fluid flows or is urged down to the reservoir or waste bottle rather than staying in the central line. In various examples of aspects, the CP/CS 102 or various components of the CP/CS 102 may be refrigerated help preserve samples.

In various embodiments, and in operation, the NC connects to a common central line that brings all the sampling module delivery lines to the pump on the CP/CS 102, thereby allowing the CP/CS pump to draw in the sampling module fluid and send it to a collector or analyzer. In various embodiments, the sampling module 3-way valve that is currently being processed by the CP/CS is switched to the NO position, which is now open to an air filter, to allow the CP/CS pump to draw in the sampling module fluid and to deliver the fluid to a single or multiple analyzers, a collector (e.g., a fraction collector) or an SBM.

In various embodiments, and in operation, the NC connects to a common central line that brings all the sampling module delivery lines to the pump on the CP/CS, thereby allowing the CP/CS pump to draw in the sampling module fluid and send it to a collector or analyzer. In various embodiments, the sampling module that is currently being processed by the CP/CS switches the multi-position valve to the air-line, which is now open to an air filter, to allow the CP/CS pump to draw in the sampling module fluid and to deliver the fluid to a single or multiple analyzers, a collector (e.g., a fraction collector) or an SBM.

While the first aspect of the CP/CS or fluid handler 102A illustrated in FIGS. 37, 38 and 45, which incorporates features of the other aspects as previously stated, includes sixteen lines operatively associated with sixteen 3-way valves 106, it will be appreciated that the CP/CS 102A may have any number of lines and 3-way valves. For example, one embodiment may have twenty-four lines operatively associated with twenty-four 3-way valves.

The second aspect of the CP/CS or fluid handler 102B illustrated in FIGS. 39 to 41, which incorporates features of the other aspects as previously stated, includes a housing 108 with multiple actuating valves 110 fluidly attached and a needle 112 extending from the housing and in fluid communication with the valves 110 through the housing 108. Fluid enters each valve from one of a sampling devices 68 and/or reactor vessels 64 through an entry port 114. The fluid travels through the housing a to the needle 112. The needle 112 is in fluid communication with a bag or vial for depositing of the fluid sample. Waste fluid exits the housing at the waste port 116. The second aspect of the CP/CS or fluid handler 102B illustrated in FIGS. 39 to 41 may operatively substitute for the first aspect of the CP/CS or fluid handler 102A.

The third aspect of the CP/CS or fluid handler 102C illustrated in FIGS. 42 to 44, which incorporates features of the other aspects as previously stated, includes a housing 108 with multiple actuating valves 110 fluidly attached and a plurality of needles 112 extending from the housing and in fluid communication with the valves 110 through the housing 108. Specifically, each needle is preferably in communication with one valve 110, alternatively one or more needles may be in communication with one or more valves 110. Fluid enters each valve from one of a sampling devices 68 and/or reactor vessels 64 through an entry port 114. The fluid travels through the housing a to the respective needle(s) 112. The needles 112 are in fluid communication each with a respective bag or vial for depositing of the fluid sample. Waste fluid exits the housing at the waste port 116. The third aspect of the CP/CS or fluid handler 102C may operatively be applied to the seventh aspect of the CP/CS or fluid handler 102G.

The fourth aspect of the CP/CS or fluid handler 102D illustrated in FIGS. 46 to 48, which incorporates features of the other aspects as previously stated, includes a housing 108A with a plurality of valves 110A for receipt of fluid from one of a sampling devices 68 and/or reactor vessels 64. The fluid passes through a series of channels 117 The fluid exits the housing through one or more of a plurality of exit ports 118. The exit port 118 may provide for transfer of the fluid to one of vials or bags, a device for testing, or remove a portion of the fluid as waste.

The fifth aspect of the CP/CS or fluid handler 102E illustrated in FIGS. 49 to 50, which incorporates features of the other aspects as previously stated, includes a housing 108B with multiple actuating valves 110B fluidly attached. Fluid enters each valve from one of a sampling devices 68 and/or reactor vessels 64 through an entry port 114. The fluid travels through the housing an either enters another housing and exits the fifth aspect of the CP/CS or fluid handler 102E or exits the fifth aspect of the CP/CS or fluid handler 102E vis the housing 108B.

The sixth aspect of the CP/CS or fluid handler 102F illustrated in FIGS. 69 to 70, which incorporates features of the other aspects as previously stated, includes a housing 108C The housing comprises opposite walls 120 and a base 122 positioned between the opposite walls 120. A railing or guidance system 124 extends along each wall 120 with the railing 124 of each wall 120 facing the other wall 120. Thus, the railings 124 on the opposite walls 120 are substantially facing one another and in line with one another. A traverse railing 126 extends between the opposite railings and is movable along the length of the rails 124. A valve 110C is movably positioned on the traverse railing 126 such that the valve 110C moves at least substantially transverse to the transverse to the length of the rails 124. The valve receives at least one but preferably four input tubes with fluid. Each tube 38 is connected to a needle 112 positioned in the direction of the base 122. Each needle 112 has the capability of being connected to more than one tube 38. It is understood the valve may house less than four needles 112. Alternatively the valve may house more than for needles for example 16 or 32 needles 112.

The seventh aspect of the CP/CS or fluid handler 102G illustrated in FIG. 71, which incorporates features of the other aspects as previously stated specifically the sixth aspect of the CP/CS or fluid handler 102F, includes a second valve 110D and attached needle for removal of fluid stored in vials or bags for the combination of the valve 110C and needle(s) 112. The fluid may be transferred for testing/analysis or storage in a vial or bag.

In various aspects, a sampling module 68 is fluidly coupled to a fraction collector. In various aspects, the fraction collector 102 has a single moving position (e.g., it moves in only one plane). In various aspects, the fraction collector 102 has multiple moving positions. In various embodiments, the fraction collector 102 has a reservoir for waste fluids. In various aspects, the fraction collector has a housing (e.g., an insulated housing) below the fraction collector, which housing may retain ice or a cold pack (or another source of cooling) to help maintain samples at a desired temperature, which may help maintain fluid properties after collection. In various aspects, the ice/cold pack is reusable. In various aspects, the fraction collector 102 includes a removable rack that is provided near (e.g., above or on top of the ice/cold pack). In various embodiments, the rack is configured to retain multiple vials/tubes. In various aspects, the fraction collector includes a cover that is provided above the rack to help insulate the rack and vials/tubes from the atmosphere and/or help cool the samples retained in vials/tubes in the rack. In various aspects, the cover of the fraction collector defines a slot in its top to allow a tubing line of the fraction collector to move between vial positions.

With that, as illustrated in FIGS. 1-71, the CP/CS or fluid handler fluid handler assembly comprises: a fluid handler 102 positioned proximate to a reservoir; one or more fluid direction valves 110 positioned on the fluid handler with each of the one or more fluid direction valves in fluid communication with a sampling device 68; a plurality of connections for fluid access to the reservoir; a second reservoir for a transfer of a portion of the fluid to waste; and a wash station to clean the fluid handler. Aspects of the fluid handler assembly further comprises: a plurality of fluid sensors, with at least one fluid sensor in fluid connection between one of the one or more fluid direction valves 110 and the sampling device 68; a plurality of containers positioned in the reservoir with each container in fluid communication with a connection of the plurality of connections, with the plurality of containers being one of bags or vials; a plurality of at least one of reservoirs and fluid handlers; a second fluid handler for removal of the fluid from the reservoir for a preparation of a fluid sample for one or more of a dilution, reagent additions, a mixing, a heating, and a delivery to one or more analytical devices where the second fluid handler has at least one needle; a result from the one or more analytical devices is communicated to one or more of a control system and a storage; and at least one of the one or more fluid direction valves comprises at least one needle in removable fluid communication with at least one reservoir.

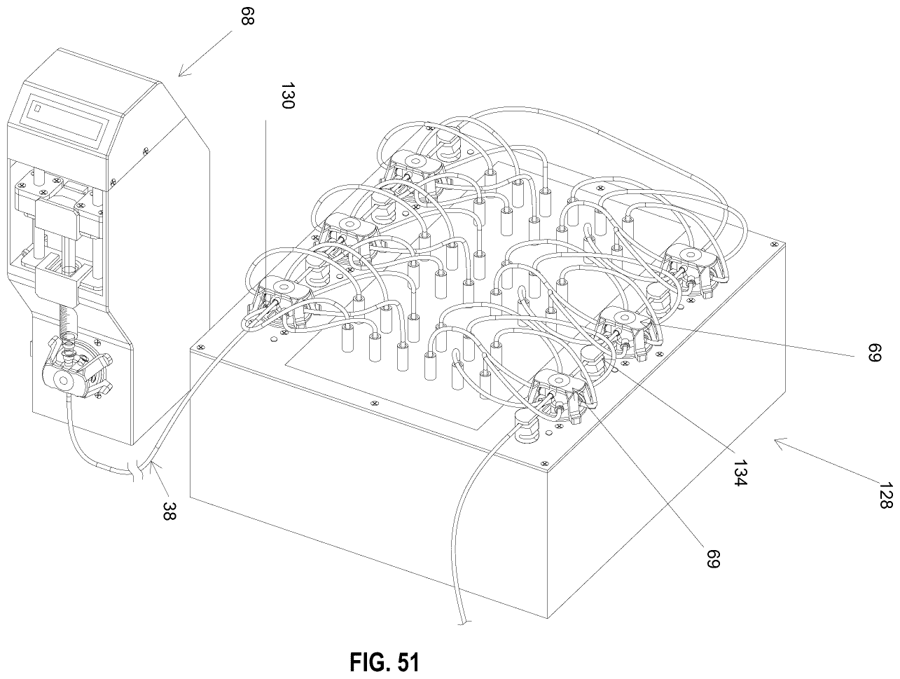

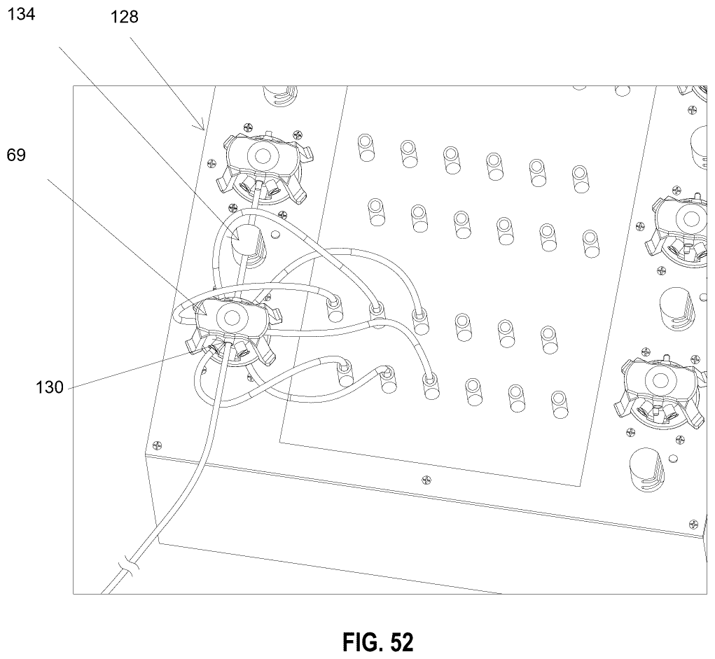

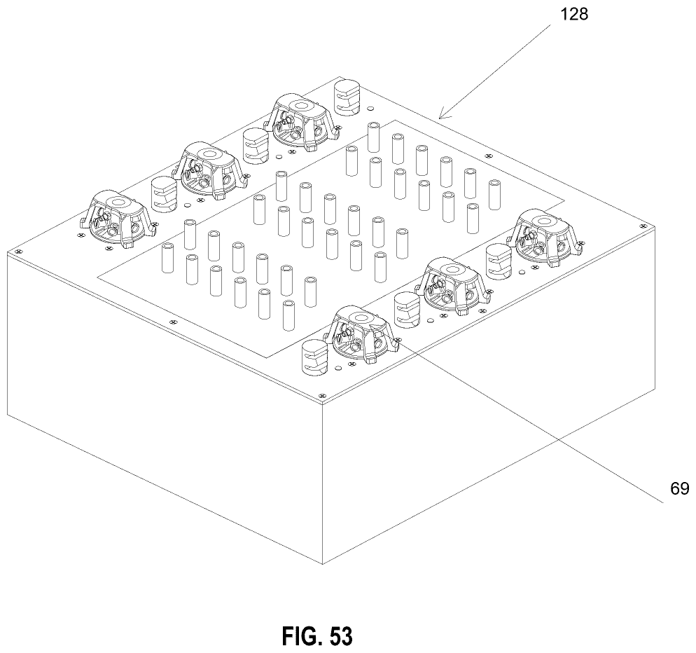

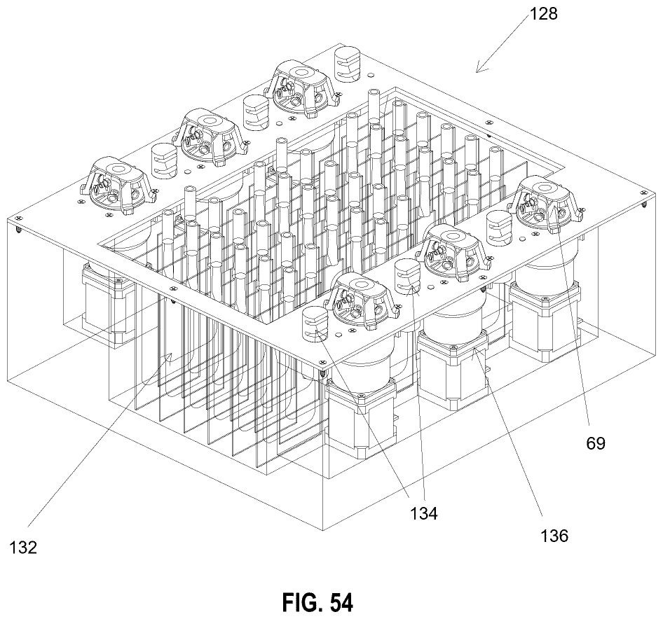

With attention to FIGS. 51 to 56, the system (e.g., system for parallel sampling) in various embodiments includes a sterile bag/reservoir manifold 128. In various aspects, the sterile bag manifold 128 includes at least one multi-position valve 69 fluidly coupled to a sampling module. In various aspects, the multi-position valve 69 includes an inlet 130 fluidly coupled to a sampling module 68, an outlet and multiple ports 73 at least some of which are fluidly coupled to individual bags or reservoirs 132 of the sterile bag manifold 128. In various embodiments, the sterile bag manifold 128 includes multiple disposable multi-position valves 69, which valves may be placed in series (and/or in parallel) and fluidly coupled to the bags or reservoirs of the sterile bag manifold 128.

In various embodiments, the multi-position valve 69 includes an unobstructed inlet coupled to a sampling module 68 or a sample distribution system such as a Director brand liquid handling system by Flownamics Analytical Instruments, Inc., WI, and an outlet. A separate valve (e.g., a pinch valve) 134 is operatively coupled to tubing in fluid communication with the outlet of the multi-position valve 69 to prevent flow of fluid from the valve 69 to another multi-position valve 69 in series as fluid is being delivered to an individual port.

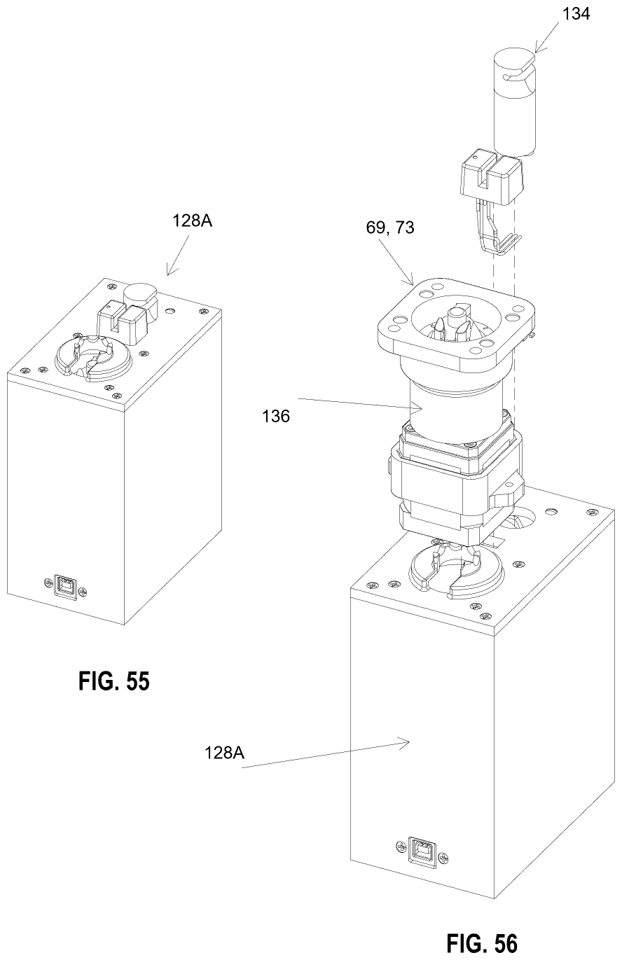

In operation, in various aspects, fluid from a vessel or other reservoir (e.g., in a closed system) is delivered or provided to bags or collection reservoirs 132 of the sterile bag manifold 128 using a disposable multi-position valve 69 with individual or independent ports 73 that are each connected to a bag/reservoir 132. In various embodiments, the disposable multi-position valve's inlet and outlet allow for the delivery or provision of fluid to each individual port 73 while preventing cross-contamination of fluids being delivered or provided. In various aspects, the fluid path is cleaned, to prevent each individual port 73 to the bag or reservoir 132 from being exposed to other fluids. In various aspects, this is accomplished by the valve 69 opening to a bag or reservoir 132 after the entire inside of the valve has been flushed with delivery fluid. In various aspects, once a bag/reservoir 132 is filled, the valve 69 moves one position which is then open to just the inlet and outlet, or the valve 69 moves to a position between two sampling ports 73. In various embodiments, this allows cleaning and flushing of the internal volume of the valve before depositing the fluid into the next bag/reservoir. One or more components, and even the entire assembly, may be sterilized by gamma irradiation or by other means. Parts of the assembly may be fitted with sterile connectors to complete the full assembly. In various embodiments, the bags/reservoirs 132 are removed from the assembly by means of a removable sterile connector or sealing the tubing between the bag and the disposable multi-position valve. In various embodiments, the bags or reservoirs of the assembly may be aliquoted (manually or automatedly to relatively smaller (e.g., single use) bags or reservoirs 132. As illustrated in FIGS. 55 and 56, a second aspect of the sterile bag/reservoir manifold 128A is described herein. The second aspect of the sterile bag manifold 128A incorporated and shares features of and with the sterile bag manifold 128. The second aspect of the sterile bag manifold 128A comprises a single port 73 or valve 69. The second aspect of the manifold 128A may be fluidly coupled in parallel and or series with multiple manifolds (128, 128A).

With that, as illustrated in FIGS. 1-71, the disposable expandable fluid containment manifold drive/manifold (128, 128A) comprises: a disposable valve 69 and a control housing 136 operably connected to one another; the disposable valve 69 has a valve assembly and at least one valve port 73; the valve assembly is operatively positioned in the disposable valve and fluidly connected with the at least one valve port 73; a fluid container fluidly connected to the at least one valve port 73; the control housing 136 is positioned to direct a fluid to the at least one valve port 73; and electronics are provided for electrical operation of one more of the control housing and the disposable valve.

Aspects of the disposable expandable fluid containment manifold drive/manifold (128, 128A) comprise: a fluid sensor fluidly connected to at least one of disposable valve 69 and the valve assembly for a detection of the fluid at an outlet of the disposable valve 69 for a delivery of the fluid to the outlet; the disposable valve 69 is a multi position valve having an open flow path from an inlet of the multi position valve to the outlet; a plurality disposable valves are in fluid connection with one another for a depositing of the fluid in a plurality of fluid containers; the disposable expandable fluid containment manifold drive is fluidly connected to one of a reactor and a process stream; the disposable valve is fluidly connected to a plurality of fluid containers positioned in a reservoir; and the control housing is a motor housing.

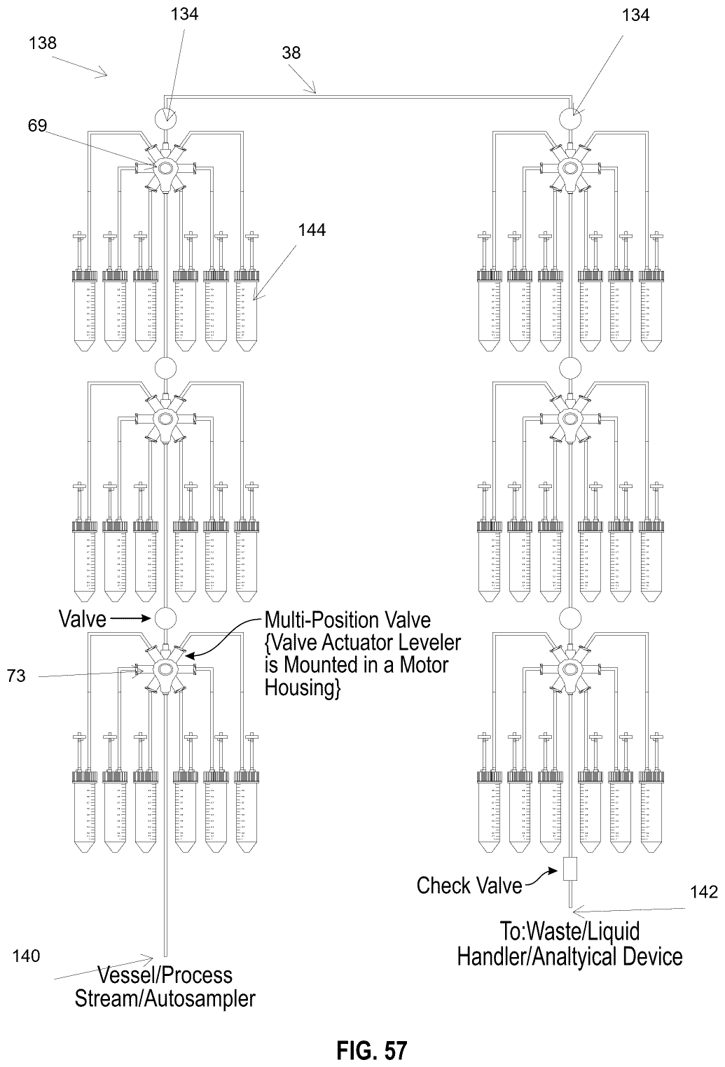

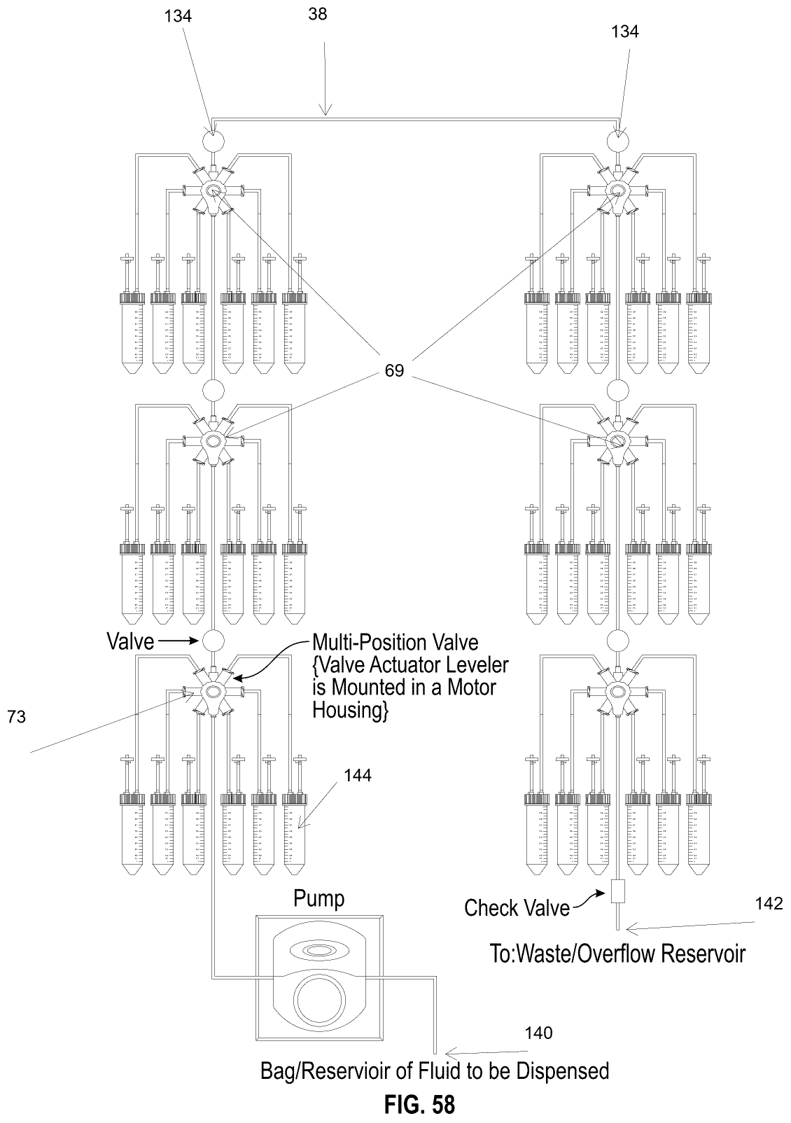

With attention to FIGS. 57 to 58, a tube manifold apparatus 138, according to various examples of aspects is disclosed. In various aspects, the tube manifold apparatus 138 includes at least one multi-position valve 69 fluidly coupled to a sampling module 68, see FIG. 19, vessel or process stream 64, see FIG. 16. In various aspects, the multi-position valve 69 includes an inlet 140 fluidly coupled to a sampling module 68, see FIG. 19, an outlet 142 and multiple ports at least some of which are fluidly coupled to individual tube or vial assemblies 144 of the tube manifold apparatus 138. In various aspects, the tube manifold apparatus 138 includes multiple disposable multi-position valves 69, which valves may be placed in series (and/or in parallel) and fluidly coupled to the tubes or vials of the tube manifold apparatus 138.

In various embodiments, the multi-position valve 69 includes an unobstructed inlet coupled to a sampling module or a sample distribution system such as a Director brand liquid handling system by Flownamics Analytical Instruments, Inc., WI, and an outlet. A separate valve (e.g., a pinch valve) 134 is operative to prevent flow of fluid from the valve 69 to another multi-position valve 69 in series as fluid is being delivered to an individual port 73.

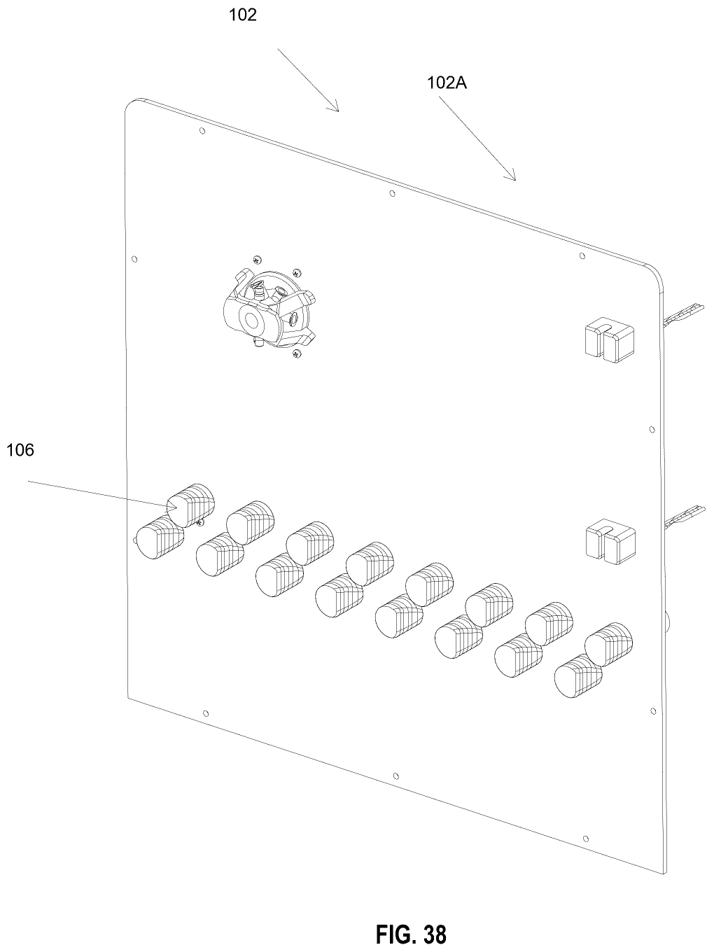

In operation, in various aspects, fluid from a vessel or other reservoir (e.g., in a closed system) is delivered or provided to a vial or tube assembly 144 of the tube manifold apparatus 138 using a disposable multi-position valve 69 with individual or independent ports 73 that are each connected to a tube/vial 144. In various aspects, the disposable multi-position valve's 69 inlet and outlet allow for the delivery or provision of fluid to each individual port 73 while preventing cross-contamination of fluids being delivered or provided. In various embodiments, the fluid path is cleaned, to prevent each individual port 73 to the vial or tube assembly 144 from being exposed to other fluids. In various aspects, this is accomplished by the valve opening to a vial or tube assembly after the entire inside of the valve has been flushed with delivery fluid. In various aspects, once a vial or tube assembly 144 is filled (as desired), the valve 69 moves one position which is then open to just the inlet and outlet, or the valve moves to a position between two sampling ports. In various aspects, this allows cleaning and flushing of the internal volume of the valve before depositing the fluid into the next vial or tube assembly 144. One or more components, and even the entire assembly 138, may be sterilized by gamma irradiation or by other means. Parts of the assembly 138 may be fitted with sterile connectors to complete the full assembly. In various embodiments, the vial or tube assembly 144 are removed from the assembly 138 by means of a removable sterile connector or sealing the tubing between the tube/vial 144 and the disposable multi-position valve 69. In various aspects, and as illustrated in FIG. 38, the tube manifold apparatus 138 may be used to aliquoted (manually or automatedly) from relatively larger reservoirs.

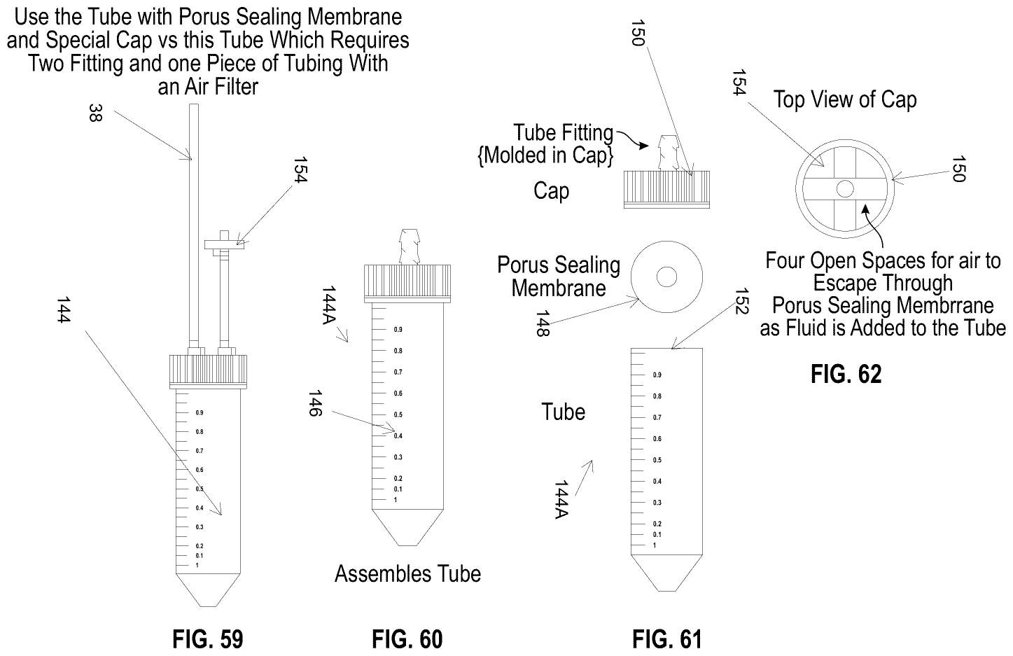

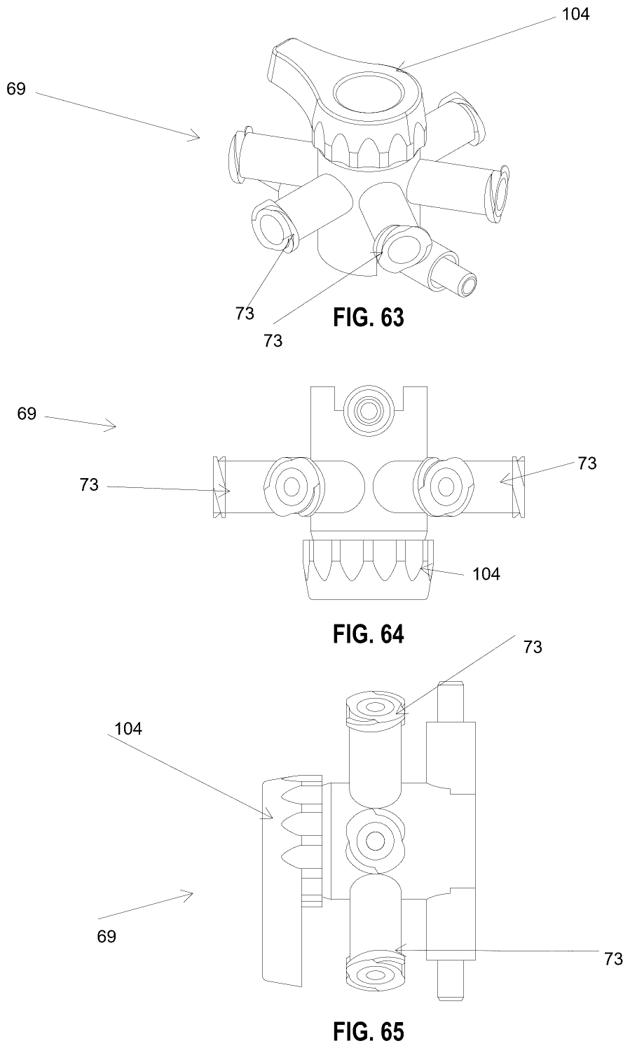

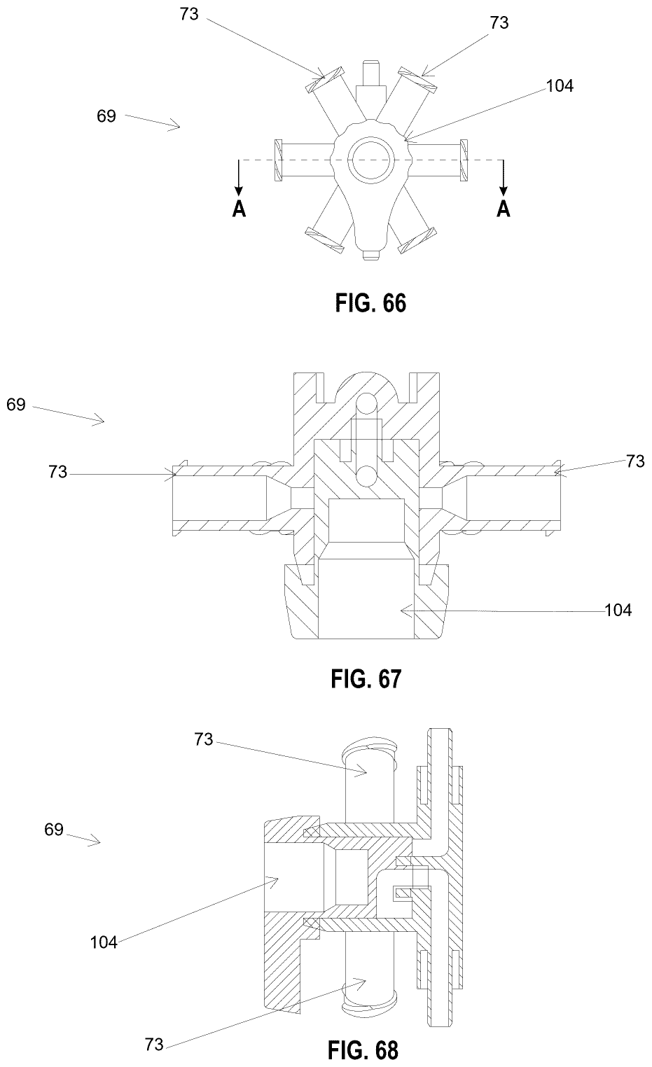

With attention to FIGS. 59 to 62, aspects of a vail or tube assembly 144 are illustrated. FIG. 59 illustrates a vial or tube assembly 144 of the tube manifold apparatus of FIGS. 57 and/or 58. FIGS. 60-62 illustrate another aspect of a vial or tube assembly 144A. As illustrated in FIGS. 60-62, in various aspects, the vial or tube assembly (144, 144A) includes a vial or tube 146, a porous sealing membrane 148 defining an inlet aperture 152, and a cap 150 having a tube fitting fluidly coupled to the inlet aperture 152 and air outlet apertures defined therein. In various aspects, the vial or tube assembly (144, 144A) can be filled as desired with fluid while air escapes the assembly through the membrane 148 and air outlet apertures 154.

With that, as illustrated in FIGS. 1-71, the filter cap vial assembly/vail or tube assembly 144 comprises: a vial 146 with an opening 152 to a vial cavity defined by a body of the vial; a cap 150 having one or more through-holes 154 in removable connection with the vial over the opening; a filter material 148 positioned between the cap 150 and the vial 146, with the combination of the one or more through-holes 154 and the filter 148 material being an access for air to be in the vial cavity to be released from the vial cavity during a filling of the vial cavity with a fluid; and a tubing 38 in fluid connection through the cap 150 with the vial cavity. The vial 146 is one of a glass and a plastic. A crimping material 134 is positioned on the tubing 38 for a sealing of the fluid in the vial cavity.

While this disclosure relates to or has otherwise been disclosed in connection with one or more bioprocess applications, it will be appreciated that the systems, apparatus, devices and methods disclosed herein could be utilized in connection with several other types of applications.

Disposable reagents/standards pack may be used with one or more disposable multi position valves of the sampling module 68, CP/CS 102 and/or SBM. In various aspects, a reagent pack is equipped with multiple bags of reagents/standards connected to the individual ports 73 on a disposable multi position valve 69 and is fitted with a sterile connector to connect it to a device. In various aspects, the reagent pack is sterile and can be installed into a system while maintaining sterility. In various aspects, the multi position valve 69 is inserted into or otherwise operatively associated with a motor or manual lever to open a common output of the multi position valve to each individual reagent/standard. If a completely sterile connection is challenging to obtain, a sterilizing fluid may be included that would initially fill the line after the non-sterile connection to sterilize the entire fluid path.

As utilized herein, “tubing” refers to tubing or piping made of plastic and/or metal. As utilized herein, a valve (such as a 3-way valve) may be any time of known (e.g., a pinch or solenoid valve) or later-developed valve. As utilized herein, “fluid” refers to any liquid or sample.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that references to relative positions (e.g., “top” and “bottom”) in this description are merely used to identify various elements as are oriented in the Figures. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members, or the two members and any additional intermediate members being integrally formed as a single unitary body with one another or with the two members or the two members and any additional intermediate members being attached to one another. Such joining may be permanent in nature or may be removable or releasable in nature.

It is also important to note that the construction and arrangement of the system, methods, and devices as shown in the various examples of embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements show as multiple parts may be integrally formed, the operation of the interfaces may be reversed or otherwise varied, the length or width of the structures and/or members or connector or other elements of the system may be varied, the nature or number of adjustment positions provided between the elements may be varied (e.g. by variations in the number of engagement slots or size of the engagement slots or type of engagement). The order or sequence of any process or method steps may be varied or re-sequenced according to alternative embodiments. Other substitutions, modifications, changes and omissions may be made in the design, operating conditions and arrangement of the various examples of embodiments without departing from the spirit or scope of the present inventions.

While this invention has been described in conjunction with the examples of embodiments outlined above, various alternatives, modifications, variations, improvements and/or substantial equivalents, whether known or that are or may be presently foreseen, may become apparent to those having at least ordinary skill in the art. Accordingly, the examples of embodiments of the invention, as set forth above, are intended to be illustrative, not limiting. Various changes may be made without departing from the spirit or scope of the invention. Therefore, the invention is intended to embrace all known or earlier developed alternatives, modifications, variations, improvements and/or substantial equivalents.

What is claimed is:

1. A disposable sampling probe comprising:
a main body having a longitudinal dimension;
a fluid path housed in the main body and operatively connected to a collection apparatus positioned along the longitudinal dimension for a transfer of a fluid;
the fluid path having an outlet opposite the collection apparatus along the longitudinal dimension;
a tubing fluidly connected to the outlet;
a check valve in fluid connection to the main body, proximate to the outlet; and
the disposable sampling probe positioned in one of a reactor and a process stream.

2. The disposable sampling probe of claim 1, wherein the main body is a two-piece main body.

3. The disposable sampling probe of claim 1, wherein the check valve is positioned in the main body.

4. The disposable sampling probe of claim 1, wherein a second check valve operatively positioned along the tubing and proximate to the outlet.

5. The disposable sampling probe of claim 4, wherein one of more of the check valve and the second check valve are positioned to operatively hinder a flow of the fluid from flowing back into one of a reactor and a process stream.

6. The disposable sampling probe of claim 1, wherein the disposable sampling probe is sterilized through one or more of radiation, chemical sterilization, stream sterilization, or in-situ sterilization.

7. The disposable sampling probe of claim 1, further comprising a second fluid path housed in the main body and extending the main body along the longitudinal dimension, with a second collection apparatus operatively connected to a second fluid path and a second outlet opposite the collection apparatus along the longitudinal dimension.

8. The disposable sampling probe of claim 7, further comprising a third check valve operatively positioned in the main body along the second fluid path and a fourth check valve operatively positioned along a second tubing operatively connected to the second outlet.

9. The disposable sampling probe of claim 1, wherein the collection apparatus is one of a filter positioned on the housing or an angled inlet port, with the angled inlet port being positioned at a 45 degree angle on a side of the main body along the longitudinal dimension, and being a hinderance to inclusion of an air or a foam in the fluid path.

10. The disposable sampling probe of claim 1, further comprising the main body slidably positioned in a probe sleave having an open end, with the main body slidably extending beyond the open end to a first position for an exposure of a first collection apparatus.

11. The disposable sampling probe of claim 10, wherein the main body is slidably extendable to a plurality of positions for an exposure of a respective subsequent collection apparatus at each of the plurality of positions, with each of the respective subsequent collection apparatuses being sealably removed prior to the exposure of the respective subsequent collection apparatus.

12. The disposable sampling probe of claim 10, further comprising a sensor for measurement of one of a fluid volume and a fluid flow rate for a determination of the slidable extension to a subsequent position.

13. A disposable expandable fluid containment manifold drive comprising:
a disposable valve and a control housing operably connected to one another;
the disposable valve having a valve assembly and at least one valve port;
the valve assembly operatively positioned in the disposable valve and fluidly connected with the at least one valve port;
a fluid container fluidly connected to the at least one valve port;
the control housing positioned to direct a fluid to the at least one valve port; and
electronics for electrical operation of one more of the control housing and the disposable valve.

14. The disposable expandable fluid containment manifold drive of claim 13, further comprising a fluid sensor fluidly connected to at least one of disposable valve and the valve assembly for a detection of the fluid at an outlet of the disposable valve for a delivery of the fluid to the outlet.

15. The disposable expandable fluid containment manifold drive of claim 14, further comprising the disposable valve being a multi position valve having an open flow path from an inlet of the multi position valve to the outlet.

16. The disposable expandable fluid containment manifold drive of claim 13, further comprising a plurality disposable valves in fluid connection with one another for a depositing of the fluid in a plurality of fluid containers.

17. The disposable expandable fluid containment manifold drive of claim 13, further comprising the disposable expandable fluid containment manifold drive is fluidly connected to one of a reactor and a process stream.

18. The disposable expandable fluid containment manifold drive of claim 13, further comprising the disposable valve is fluidly connected to a plurality of fluid containers positioned in a reservoir.

19. The disposable expandable fluid containment manifold drive of claim 13, further comprising the control housing is a motor housing.
